(19) United States
(12) Patent Application Publication
(10) Pub. No.: US 2009/0264289 A1
(43) Pub. Date: Oct. 22, 2009

(54) Use of Arylcarboxylic Acid Biphenylamides for Seed Treatment

(75) Inventors: Jochen Dietz, Mannheim (DE); Siegfried Strathmann, Limburgerhof (DE); Reinhard Stierl, Kaohsiung County (TW); Jurith Montag, Limburgerhof (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/299,087

(22) PCT Filed: May 2, 2007
(86) PCT No.: PCT/EP07/54265

§ 371 Date: Oct. 30, 2008

(30) Foreign Application Priority Data
May 3, 2006 (EP) 06113450.8

(51) Int. Cl. A01C 1/06; A01N 25/26; A01P 3/00; A01N 43/56; A01N 43/78; A01N 37/18; A01N 43/40

(52) U.S. Cl. 504/100; 514/406; 514/365; 514/617; 514/355

(57) ABSTRACT

The invention relates to the use of arylcarbonic acid biphenylamides of formula (I)

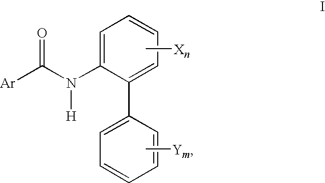

wherein
X is halogen or methyl;
n is zero, 1 or 2;
Y is cyano, nitro, halogen, C₁-C₄-alkyl, C₁-C₄-haloalkyl, C₁-C₄-alkoxy, C₁-C₄-halo-alkoxy, C₁-C₄-alkylthio, C₁-C₄-haloalkylthio, C₁-C₄-alkoxy-iminomethyl or allyloxy-iminomethyl;
m is zero to 5;
Ar is an aryl radical of the formula IIa, IIb or IIc

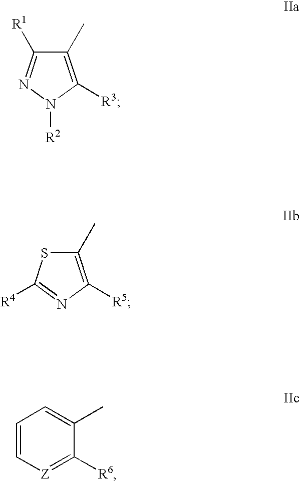

wherein
R¹ is hydrogen, halogen, C₁-C₄-alkyl or C₁-C₄-haloalkyl,
R² is C₁-C₄-alkyl,
R³ is hydrogen, halogen or methyl,
R⁴ is hydrogen, halogen or C₁-C₄-alkyl,
R⁵ is C₁-C₄-alkyl or C₁-C₄-haloalkyl,
Z is CH or N and
R⁶ is halogen, C₁-C₄-alkyl or C₁-C₄-haloalkyl,
   for seed treatment for protecting plants after germination from the attack of foliar phytopathogenic fungi and corresponding methods of seed treatment for protecting plants after germination from the attack of foliar phytopathogenic fungi. The invention also relates to seed treatment formulations comprising the arylcarboxylic acid biphenylamides of formula (I), and to seeds treated therewith.

The invention relates to a method for protecting plants after germination from the attack of foliar phytopathogenic fungi, which comprises treating the seed from which the plants are to grow with an effective amount of at least one arylcarboxylic acid biphenylamide of the formula I

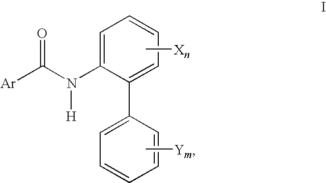

wherein
X is halogen or methyl;
n is zero, 1 or 2, where in case that n is 2, the radicals X may have the same or different meanings;
Y is cyano, nitro, halogen, C₁-C₄-alkyl, C₁-C₄-haloalkyl, C₁-C₄-alkoxy, C₁-C₄-halo-alkoxy, C₁-C₄-alkylthio, C₁-C₄-haloalkylthio, C₁-C₄-alkoxy-iminomethyl or allyloxy-iminomethyl;
m is zero to 5, where in case that m is 2, 3, 4 or 5, the radicals Y may have the same or different meanings;
Ar is an aryl radical of the formula IIa, IIb or IIc

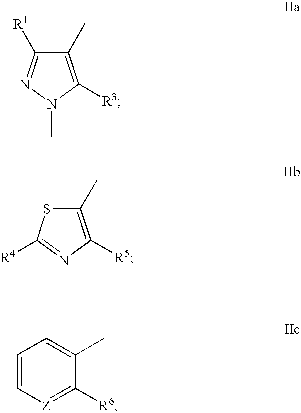

wherein
R¹ is hydrogen, halogen, C₁-C₄-alkyl or C₁-C₄-haloalkyl,
R² is C₁-C₄-alkyl,
R³ is hydrogen, halogen or methyl,
R⁴ is hydrogen, halogen or C₁-C₄-alkyl,
R⁵ is C₁-C₄-alkyl or C₁-C₄-haloalkyl,
Z is CH or N and
R⁶ is halogen, C₁-C₄-alkyl or C₁-C₄-haloalkyl
   or with an agriculturally acceptable salt thereof.

The invention further relates to the use of at least one arylcarboxylic acid biphenylamide of the formula I as defined above or of an agriculturally acceptable salt thereof for treating seed for protecting the plants which are to grow from the seed after germination from the attack of foliar phytopathogenic fungi.

The invention also relates to seed treatment compositions, and to seeds.

Until recently, in the most important regions for the cultivation of leguminous plants (in particular soybeans) there were no infections with harmful fungi that were of economic significance.

However, over recent years, there has been an increase in severe rust infections of soybean crops in South America by the harmful fungi Phakopsora pachyrhizi and Phakopsora meibomiae. There have been considerable harvest and yield losses.

Most customary fungicides are unsuitable for controlling rust in soybeans, or their action against the rust fungus is unsatisfactory.

Fungal attack, of course, is a severe problem in other crops, too, such as cereals and vegetables.

During the time period before and during germination and sprouting plants tend to be especially vulnerable to an attack of phytopathogenic fungi, not only because of the low size of the developing plant organs which makes them incapable of coping with much damage, but also because some of the natural plant defense mechanisms are not yet developed at that stage of development. Protection of plants in the pre- and post-germination stage is therefore instrumental in reducing damage.

However, the conventional application of fungicides to plants and their environment can suffer from a large number of disadvantages: Resistance to a given fungicide often develops quickly, especially if usage is very widespread, so new agents will have to be developed continually. The possible detrimental effects of fungicides on public health and on the environment are a matter of public concern. More specifically, lavish use of fungicides is not only expensive but also poses a serious health hazard to agricultural laborers; this is a particular concern for dusts or dustable powders. It is therefore advisable to use as low dosages as possible. Moreover, the efficacy of fungicides against soil-borne fungi, especially against subterraneous species, leaves much to be desired. Proper management of the fungi requires good timing and much hands-on work and may, depending on the formulation used, be very sensitive to abiotic factors which are difficult to control, such as wind, temperature, and rain fall. There is always the generally undesirable possibility of fungicides diffusing away from the desired site of action (“fungicide drift”).

Ideally, the fungicide should therefore be effective in comparatively low dosages, not liable to large-scale diffusion into the environment and away from the crops to be protected (thereby leading to undesired “bystander effects”), and suitable for such procedures as minimize both exposure of humans and hands-on time. Furthermore, it should be active against a broad spectrum of phytopathogenic fungi and preferably combine immediate effects (“knock-down”) with prolonged control.

An object of the present invention was to provide a method for the protection of crops from damage by phytopathogenic fungi. Preferably, it should also solve the problem of reducing the dosage rate, combine knock-down activity with prolonged control and/or be suitable for resistance management. Surprisingly, it has now been found that treatment of unsown plant seeds with the arylcarboxylic acid biphenylamides I not only protects the seeds themselves, but surprisingly also provides post-emergence control of phytopathogenic fungi that damage the seeds or the plants that grow from the seeds, i.e. the seed treatment has a prophylactic antifungal effect on the plants that grow from the treated seeds after the germination and also after the emergence of the plants.

The invention therefore relates to the use of an arylcarboxylic acid biphenylamides I as defined above for treating seed for protecting the plants that grow from the seed after germination, and even after emergence, from the attack of foliar phytopathogenic fungi and to a method for protecting plants after germination, and even after emergence, from the attack of foliar phytopathogenic fungi, which comprises treatment of seed with an effective amount of said arylcarboxylic acid biphenylamide I.

Preferably, the method and the use according to the invention serve for protecting plants after emergence, specifically for protecting plants when they are in the growth stage BBCH 09 or higher (according to the BBCH extended scale; German Federal Biological Research Centre for Agriculture and Forestry; see www.bba.de/veroeff/bbch/bbcheng.pdf). This object is achieved by treating the seeds from which the plants are to grow as described above and in the following. This is surprising because up to now, the arylcarboxylic acid biphenylamides of the formula I were only known to protect the seeds as such from fungal attack; a prophylactic fungicidal effect on the plants that grow from the seeds not having been known.

The invention offers several advantages: It focuses fungicide effects on crops and the fungi, thereby minimizing human exposure and environmental side-effects as well as the total dosage required, is effective against underground plant diseases as well as foliar pathogens (i.e. foliar phytopathogenic fungi), less dependant on abiotic factors and conveniently applied.

The arylcarboxylic acid biphenylamides I are known, for example, from EP-A 545099, EP-A 589301, WO 99/09013, WO 2005/123689, WO 2005/123690, WO 2003/069995, WO 2003/070705, WO 2003/066609 and WO 2003/066610, or are can be prepared according to the methods described therein.

Suitable compounds of the formula I encompass all possible stereoisomers (cis/trans isomers, enantiomers) which may occur and mixtures thereof. Stereoisomeric centers are e.g. the carbon and nitrogen atom of the alkoxy-iminomethyl or allyloxyiminomethyl moiety as well as asymmetric carbon atoms. The present invention provides both the use of the pure enantiomers or diastereomers or of the mixtures thereof, of the pure cis- and trans-isomers and of the mixtures thereof. The compounds of the general formula I may also exist in the form of different tautomers. The invention comprises the use of the single tautomers, if separable, as well as of the tautomer mixtures.

Suitable agriculturally useful salts are especially the acid addition salts of those acids whose anions, have no adverse effect on the fungicidal action of the compounds I. Anions of useful acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and also the anions of C₁-C₄-alkanoic acids, preferably formate, acetate, propionate and butyrate. They can be formed by reacting I with an acid of the corresponding anion, preferably hydrochloric acid, hydrobromic acid, sulfuric acid, phosphoric acid or nitric acid.

The compounds of the formula I may be present in various crystal modifications which may differ in their biological activity. Their use also forms part of the subject matter of the present invention.

The term halogen denotes in each case fluorine, bromine, chlorine or iodine.

The term “C₁-C₄-alkyl” as used herein refers to a branched or unbranched saturated hydrocarbon group having 1 to 4 carbon atoms, for example methyl, ethyl, propyl, 1-methylethyl, butyl, 1-methylpropyl, 2-methylpropyl and 1,1-dimethylethyl.

The term “C₁-C₄-alkoxy” refers to straight-chain or branched alkyl groups having 1 to 4 carbon atoms (as mentioned above) bonded through oxygen linkages at any bond in the alkyl group. Examples include methoxy, ethoxy, propoxy, isopropoxy, butoxy, sec-butoxy, isobutoxy and tert-butoxy.

The term “C₁-C₄-alkoxy-iminomethyl” refers to straight-chain or branched alkyl groups having 1 to 4 carbon atoms (as mentioned above) bonded through O—N═CH— linkages at any bond in the alkyl group. Examples include methoxy-iminomethyl, ethoxy-iminomethyl, propoxy-iminomethyl, isopropoxy-iminomethyl, butoxy-iminomethyl, sec-butoxy-iminomethyl, isobutoxy-iminomethyl and tert-butoxy-iminomethyl.

The term “C₁-C₄-alkylthio” refers to straight-chain or branched alkyl groups having 1 to 4 carbon atoms (as mentioned above) bonded through sulfur linkages at any bond in the alkyl group. Examples include methylthio, ethylthio, propylthio, isopropylthio, butylthio, sec-butylthio, isobutylthio and tert-butylthio.

The term “C₁-C₄-haloalkyl” as used herein refers to a straight-chain or branched alkyl group having 1 to 4 carbon atoms (as mentioned above), where some or all of the hydrogen atoms in these groups are replaced by halogen atoms as mentioned above, for example C₁-C₂ haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl or pentafluoroethyl, or C₃-C₄ haloalkyl, such as 2-fluoropropyl, 3-fluoropropyl, 2,2-difluoropropyl, 2,3-difluoropropyl, 2-chloropropyl, 3-chloropropyl, 2,3-dichloropropyl, 2-bromopropyl, 3-bromopropyl, 3,3,3-trifluoropropyl, 3,3,3-trichloropropyl, 2,2,3,3,3-pentafluoropropyl, heptafluoropropyl, 1-(fluoromethyl)-2-fluoroethyl, 1-(chloromethyl)-2-chlorethyl, 1,1,1,3,3,3-hexafluoro-2-propyl, heptafluoro-2-propyl, 1-(bromomethyl)-2-bromoethyl, 4-fluorobutyl, 4-chlorobutyl, 4-bromobutyl or nonafluorobutyl.

The term “C₁-C₄-haloalkoxy” refers to straight-chain or branched alkyl groups having 1 to 4 carbon atoms (as mentioned above) bonded through oxygen linkages at any bond in the alkyl group, where some or all of the hydrogen atoms in these groups are replaced by halogen atoms as mentioned above, for example C₁-C₂ haloalkoxy, such as chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoro-ethoxy, 2,2-dichloro-2-fluoroethoxy, 2,2,2-trichloroethoxy and pentafluoroethoxy, or C₃-C₄ haloalkoxy, such as 2-fluoropropoxy, 3-fluoropropoxy, 2,2-difluoropropoxy, 2,3-di-fluoropropoxy, 2-chloropropoxy, 3-chloropropoxy, 2,3-dichloropropoxy, 2-bromoprop-oxy, 3-bromopropoxy, 3,3,3-trifluoropropoxy, 3,3,3-trichloropropoxy, 2,2,3,3,3-penta-fluoropropoxy, heptafluoropropoxy, 1-(fluoromethyl)-2-fluoroethoxy, 1-(chloromethyl)-2-chlorethoxy, 1-(bromomethyl)-2-bromoethoxy, 4-fluorobutoxy, 4-chlorobutoxy, 4-bromobutoxy or nonafluorobutoxy.

The term “C₁-C₄-haloalkylthio” refers to straight-chain or branched alkyl groups having 1 to 4 carbon atoms (as mentioned above) bonded through sulfur linkages at any bond in the alkyl group, where some or all of the hydrogen atoms in these groups are replaced by halogen atoms as mentioned above, for example C₁-C₂ haloalkylthio, such as chloromethylthio, bromomethylthio, dichloromethylthio, trichloromethylthio, fluoromethylthio, difluoromethylthio, trifluoromethylthio, chlorofluoromethylthio, dichlorofluoromethylthio, chlorodifluoromethylthio, 1-chloroethylthio, 1-bromoethylthio, 1-fluoro-ethylthio, 2-fluoroethylthio, 2,2-difluoroethylthio, 2,2,2-trifluoroethylthio, 2-chloro-2-fluoroethylthio, 2-chloro-2,2-difluoroethylthio, 2,2-dichloro-2-fluoroethylthio, 2,2,2-trichloroethylthio and pentafluoroethylthio, or C₃-C₄-haloalkylthio, such as 2-fluoro-propylthio, 3-fluoropropylthio, 2,2-difluoropropylthio, 2,3-difluoropropylthio, 2-chloro-propylthio, 3-chloropropylthio, 2,3-dichloropropylthio, 2-bromopropylthio, 3-bromo-propylthio, 3,3,3-trifluoropropylthio, 3,3,3-trichloropropylthio, 2,2,3,3,3-pentafluoro-propylthio, heptafluoropropylthio, 1-(fluoromethyl)-2-fluoroethylthio, 1-(chloromethyl)-2-chlorethylthio, 1-(bromomethyl)-2-bromoethylthio, 4-fluorobutylthio, 4-chlorobutylthio, 4-bromobutylthio or nonafluorobutylthio.

Among the arylcarboxylic acid biphenylamide of formula (I), preference is given to those in which the variables, both on their own and in any combination with one another, have the meanings given below:
X fluorine, chlorine or methyl, in particular fluorine or methyl, very particularly preferred fluorine;
Y halogen, methyl, halomethyl, methoxy, halomethoxy, haloethoxy, methylthio, halomethylthio or methoxy-iminomethyl, more preferably halogen, methyl, trifluoromethyl, methoxy, difluoromethoxy, trifluoromethoxy, tetrafluoroethoxy, methylthio, difluoromethylthio, trifluoromethylthio, methoxy-iminomethyl or allyloxy-iminomethyl, in particular halogen, methyl, trifluoromethyl or trifluoromethylthio, with particular preference halogen, methyl, trifluoromethyl, trifluoromethoxy, tetrafluoroethoxy or trifluoromethylthio, very particularly preferred fluorine or chlorine;
m zero, one, two or three, more preferably one, two or three, in particular two or three; if m is two or three, the radicals Y may have the same or different meanings;
n zero or one, in particular zero;

R¹ methyl or halomethyl, more preferably methyl, fluoromethyl, difluoromethyl, chlorofluoromethyl or trifluoromethyl, in particular halomethyl, preference being given to difluoromethyl, chlorofluoromethyl and trifluoromethyl, more preference being given to difluoromethyl and trifluoromethyl, with particular preference difluoromethyl;
R² methyl;
R³ hydrogen, fluorine or chlorine, in particular hydrogen;
R⁴ C₁-C₄-alkyl, in particular methyl;
R⁵ methyl or halomethyl, in particular methyl, difluoromethyl or trifluoromethyl, with particular preference difluoromethyl or trifluoromethyl;
R⁶ halogen, methyl or halomethyl, in particular fluorine, chlorine, iodine, methyl, difluoromethyl or trifluoromethyl, with particular preference chlorine, iodine or trifluoromethyl, specifically chlorine.

One embodiment of the present invention relates to compounds of the formula I, wherein X is methyl.

Another embodiment of the present invention relates to compounds of the formula I, wherein Y is fluorine.

Another embodiment of the present invention relates to compounds of the formula I, wherein Y is chlorine.

Another embodiment of the present invention relates to compounds of the formula I, wherein m is zero.

Another embodiment of the present invention relates to compounds of the formula I, wherein m is one.

Another embodiment of the present invention relates to compounds of the formula I, wherein n is one.

One preferred embodiment of the present invention relates to compounds of the formula Ia

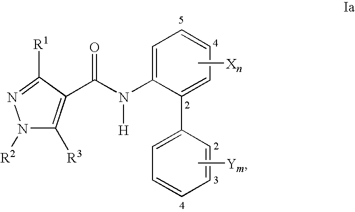

wherein X, Y, m, n, R¹, R² and R³ are as defined herein and preferably have the meanings depicted above as being preferred. Amongst compounds Ia, preference is given to those, wherein m is zero to three, preferably 1, 2 or 3, more preferably 2 or 3, and n is zero or one.

Further preference is given to those compounds Ia, wherein R³ is hydrogen.

Further preference is given to those compounds Ia, wherein R³ is fluorine.

Further preference is given to those compounds Ia, wherein R³ is chlorine.

Further preference is given to those compounds Ia, wherein R¹ is halogenated methyl, preferably CF₃, CHF₂ or CHFCl, more preferably CF₃ or CHF₂ and in particular CHF₂.

Further preference is given to those compounds Ia, wherein R² is methyl.

Further preference is given to those compounds Ia, wherein X is halogen, specifically fluorine.

Further preference is given to those compounds Ia, wherein Y is halogen, specifically fluorine or chlorine, methyl or SCF₃, more preferably fluorine or chlorine.

Compounds Ia depicted in the following Table 1 (R² being methyl except for compound no. Ia.212, where R² is ethyl) are very particularly preferred:

TABLE 1

| Compound | R¹ | R³ | Xₙ | Yₘ | m.p. [° C.] |
|---|---|---|---|---|---|
| Ia.1 | CH₃ | Cl | — | — | 108-109 |
| Ia.2 | CHF₂ | H | — | — | 113-119 |
| Ia.3 | CF₃ | H | — | — | 147-148 |
| Ia.4 | CF₃ | H | — | 4-Cl | 151-153 |
| Ia.5 | CF₃ | H | — | 4-OCH₃ | 152-154 |
| Ia.6 | CF₃ | H | — | 4-F | 156-157 |
| Ia.7 | CF₃ | H | — | 3-Cl | 92-94 |
| Ia.8 | CF₃ | H | — | 2-CH₃ | 119-122 |
| Ia.9 | CH₃ | H | — | — | 158-160 |
| Ia.10 | CH₃ | H | — | 4-Cl | 165-166 |
| Ia.11 | CH₃ | H | — | 4-OCH₃ | 156-157 |
| Ia.12 | CH₃ | H | — | 4-F | 175-176 |
| Ia.13 | CH₃ | H | — | 3-Cl | 104-106 |
| Ia.14 | CH₃ | H | — | 2-CH₃ | 137-139 |
| Ia.15 | Cl | H | — | — | 201-206 |
| Ia.16 | CF₃ | H | — | 4-C(CH₃)₃ | 189-195 |
| Ia.17 | CH₃ | H | — | 4-C(CH₃)₃ | 184-189 |
| Ia.18 | CF₃ | H | — | 3-F | 115-120 |
| Ia.19 | CF₃ | H | — | 4-CH(CH₃)₂ | 202-204 |
| Ia.20 | CF₃ | H | — | 3-CH₃ | 97-99 |
| Ia.21 | CH₃ | Cl | — | 4-F | 147-152 |
| Ia.22 | CH₃ | Cl | — | 4-Cl | 180-183 |
| Ia.23 | CH₃ | Cl | — | 4-OCH₃ | 135-143 |
| Ia.24 | CF₃ | H | 4-F | 4-F | 135-138 |
| Ia.25 | CF₃ | H | 4-F | 4-Cl | 136-140 |
| Ia.26 | CF₃ | H | 4-F | 4-CH₃ | 148-151 |
| Ia.27 | CH₃ | H | 4-F | 4-F | 162-166 |
| Ia.28 | CH₃ | H | 4-F | 4-Cl | 160-164 |
| Ia.29 | CH₃ | H | 4-F | 4-CH₃ | 154-157 |
| Ia.30 | CF₃ | H | 5-F | 4-F | 165-170 |
| Ia.31 | CF₃ | H | 3-F | 4-F | 124-126 |
| Ia.32 | CF₃ | H | 3-F | 4-Cl | 127-128 |
| Ia.33 | CH₃ | F | — | 4-Cl | 135-139 |
| Ia.34 | CH₃ | F | — | 4-CH₃ | 113-114 |
| Ia.35 | CH₃ | F | — | 4-F | 138-139 |
| Ia.36 | CH₃ | F | — | — | 147-150 |
| Ia.37 | CH₃ | F | — | 4-(CH═N—OCH₃) | 123-124 |
| Ia.38 | CF₃ | H | — | 3-Cl, 4-Cl | 131-133 |
| Ia.39 | CF₃ | H | — | 3-Cl, 4-F | 133-134 |
| Ia.40 | CF₃ | H | — | 2-Cl, 4-Cl | 136-140 |
| Ia.41 | CF₃ | H | — | 3-F, 4-F | 126-128 |
| Ia.42 | CF₃ | H | — | 3-Cl, 5-Cl | 101-105 |
| Ia.43 | CHF₂ | H | — | 3-Cl, 5-Cl | 131-132 |
| Ia.44 | CHF₂ | H | — | 3-Cl, 4-F | 129-130 |
| Ia.45 | CHF₂ | H | — | 3-F, 4-F | 122-123 |
| Ia.46 | CHF₂ | H | — | 3-Cl, 4-Cl | 129-130 |
| Ia.47 | CHF₂ | H | — | 2-Cl, 4-Cl | 123-124 |
| Ia.48 | CH₃ | CH₃ | — | 4-Cl | 104-108 |
| Ia.49 | CH₃ | Cl | — | 3-Cl, 4-Cl | 104-108 |
| Ia.50 | CH₃ | Cl | — | 2-Cl, 4-Cl | 117-122 |
| Ia.51 | CH₃ | Cl | — | 3-Cl, 4-F | 134-137 |
| Ia.52 | CH₃ | Cl | — | 3-Cl, 5-Cl | 135-139 |
| Ia.53 | CF₃ | H | — | 4-CH₃ | 163-165 |
| Ia.54 | CF₃ | H | — | 4-CF₃ | 175-177 |
| Ia.55 | CF₃ | H | — | 2-F, 5-F | 110-112 |
| Ia.56 | CF₃ | H | — | 2-CF₃ | 120-121 |
| Ia.57 | CF₃ | H | — | 2-F, 4-Cl | 136-138 |
| Ia.58 | CF₃ | H | — | 2-CH₃, 4-Cl | 130-131 |
| Ia.59 | CF₃ | H | — | 3-CH₃, 4-Cl | 109-111 |
| Ia.60 | CF₃ | H | — | 2-CH₃, 4-F | 125-126 |
| Ia.61 | CF₃ | H | — | 3-CH₃, 4-F | 126-127 |
| Ia.62 | CF₃ | H | — | 3-F, 4-Cl | 149-150 |
| Ia.63 | CF₃ | H | — | 2-F, 4-F | 100-102 |
| Ia.64 | CF₃ | H | — | 3-CF₃ | 132-134 |
| Ia.65 | CF₃ | H | — | 4-CN | 200-201 |
| Ia.66 | CF₃ | H | — | 2-F, 4-OCH₃ | 102-104 |
| Ia.67 | CF₃ | H | — | 2-F, 6-F | 141-143 |
| Ia.68 | CHF₂ | H | — | 4-CF₃ | 164-165 |
| Ia.69 | CHF₂ | H | — | 3-CF₃ | 124-125 |
| Ia.70 | CHF₂ | H | — | 2-CF₃ | 133-134 |
| Ia.71 | CHF₂ | H | — | 2-F, 5-F | 139-141 |
| Ia.72 | CHF₂ | H | — | 2-F, 4-F | 90-92 |
| Ia.73 | CHF₂ | H | — | 2-F, 4-Cl | 124-126 |
| Ia.74 | CHF₂ | H | — | 3-F, 4-Cl | 166-167 |
| Ia.75 | CHF₂ | H | — | 2-CH₃, 4-F | 123-124 |
| Ia.76 | CHF₂ | H | — | 3-CH₃, 4-F | 130-132 |
| Ia.77 | CHF₂ | H | — | 2-CH₃, 4-Cl | 155-156 |
| Ia.78 | CHF₂ | H | — | 3-CH₃, 4-Cl | 145-146 |
| Ia.79 | CHF₂ | H | — | 4-CN | 214-216 |
| Ia.80 | CHF₂ | H | — | 2-CH₃, 4-OCH₃ | 84-86 |
| Ia.81 | CHF₂ | H | — | 4-F | 153-155 |
| Ia.82 | CHF₂ | H | — | 4-Cl | 158-160 |
| Ia.83 | CF₃ | H | — | 2-F, 4-Cl, 5-OCH₃ | |
| Ia.84 | CF₃ | H | — | 2-F, 4-Cl, 5-CH₃ | 106-108 |
| Ia.85 | CF₃ | H | — | 3-F, 4-F, 5-F | 120-124 |
| Ia.86 | CF₃ | H | — | 2-F, 4-F, 5-F | 110-113 |
| Ia.87 | CHF₂ | H | — | 2-F, 4-Cl, 5-OCH₃ | 150-152 |
| Ia.88 | CF₃ | H | — | 2-F, 3-F, 4-F | 123-125 |
| Ia.89 | CHF₂ | H | — | 2-F, 4-Cl, 5-CH₃ | 120-122 |
| Ia.90 | CHF₂ | H | — | 3-F, 4-F, 5-F | 113-116 |
| Ia.91 | CHF₂ | H | — | 2-F, 4-F, 5-F | |
| Ia.92 | CH₃ | H | — | 3-Cl, 4-Cl | |
| Ia.93 | CH₃ | H | — | 2-Cl, 4-Cl | |
| Ia.94 | CH₃ | H | — | 3-F, 4-F | 140-143 |
| Ia.95 | CH₃ | H | — | 3-Cl, 4-F | 177-180 |
| Ia.96 | CH₃ | H | — | 3-Cl, 5-Cl | |
| Ia.97 | CH₃ | H | — | 3-F, 4-Cl | 181-186 |
| Ia.98 | CH₃ | H | — | 2-F, 4-F | |
| Ia.99 | CH₃ | H | — | 2-F, 4-Cl | 122-125 |
| Ia.100 | CH₃ | H | — | 4-CN | 147-151 |
| Ia.101 | CF₃ | H | 4-F, 6-Cl | 2-Cl, 4-Cl | |
| Ia.102 | CHF₂ | H | 4-F, 6-Cl | 3-Cl, 4-Cl | 147-152 |
| Ia.103 | CHF₂ | H | 4-F, 6-Cl | 3-F, 4-F | |
| Ia.104 | CF₃ | H | 5-F | 3-Cl, 4-Cl | 155-158 |
| Ia.105 | CF₃ | H | 5-F | 3-F, 4-F | 159-161 |
| Ia.106 | CHF₂ | H | 5-F | 3-Cl, 4-Cl | 100-105 |
| Ia.107 | CHF₂ | H | 5-F | 3-F, 4-F | |
| Ia.108 | CF₃ | H | 4-F | 3-Cl, 4-Cl | 108-113 |
| Ia.109 | CF₃ | H | 4-F | 3-F, 4-F | 127-133 |
| Ia.110 | CHF₂ | H | 4-F | 3-Cl, 4-Cl | 141-143 |
| Ia.111 | CHF₂ | H | 4-F | 3-F, 4-F | 136-141 |
| Ia.112 | CF₃ | H | 4-F | 2-Cl, 4-Cl | 131-136 |
| Ia.113 | CHF₂ | H | 4-F | 2-Cl, 4-Cl | 122-128 |
| Ia.114 | CF₂—Cl | H | — | 4-F | 128-130 |
| Ia.115 | CF₂—Cl | H | — | 4-Cl | 136-138 |
| Ia.116 | CF₂—Cl | H | — | 3-Cl, 4-Cl | 131-133 |
| Ia.117 | CF₂—Cl | H | — | 3-Cl, 4-F | 120-121 |
| Ia.118 | CF₂—Cl | H | — | 3-F, 4-F | 138-139 |
| Ia.119 | CF₂—Cl | H | — | 3-Cl, 5-Cl | 118-119 |
| Ia.120 | CF₂—Cl | H | — | 2-Cl, 4-Cl | 126-127 |
| Ia.121 | CF₃ | F | — | 4-F | 141-143 |
| Ia.122 | CF₃ | F | — | 4-Cl | 152-153 |
| Ia.123 | CF₃ | F | — | 3-Cl, 4-F | 159-160 |
| Ia.124 | CF₃ | F | — | 3-Cl, 5-Cl | 158-159 |
| Ia.125 | CF₃ | F | — | 2-Cl, 4-Cl | 132-134 |
| Ia.126 | CF₃ | F | — | 3-Cl, 4-Cl | 148-150 |
| Ia.127 | CF₃ | F | — | 4-CN | 178-180 |
| Ia.128 | CHF—Cl | H | — | 4-Cl | 136-138 |
| Ia.129 | CHF—Cl | H | — | 4-F | 129-131 |
| Ia.130 | CHF—Cl | H | — | 3-Cl, 4-Cl | 122-124 |
| Ia.131 | CHF—Cl | H | — | 3-Cl, 4-F | 85-87 |
| Ia.132 | CHF—Cl | H | — | 3-F, 4-F | 137-138 |
| Ia.133 | CHF—Cl | H | — | 3-Cl, 5-Cl | 100-102 |
| Ia.134 | CHF—Cl | H | — | 2-Cl, 4-Cl | 142-144 |
| Ia.135 | CH₂F | H | — | 4-Cl | 155-157 |
| Ia.136 | CH₂F | H | — | 4-F | 145-147 |
| Ia.137 | CH₂F | H | — | 3-Cl, 4-Cl | 134-136 |
| Ia.138 | CH₂F | H | — | 3-Cl, 4-F | 133-134 |
| Ia.139 | CH₂F | H | — | 3-F, 4-F | 141-143 |
| Ia.140 | CH₂F | H | — | 3-Cl, 5-Cl | 135-137 |
| Ia.141 | CH₂F | H | — | 2-Cl, 4-Cl | 111-112 |
| Ia.142 | CF(Cl₂) | H | — | 4-Cl | 155-156 |
| Ia.143 | CF(Cl₂) | H | — | 4-F | 139-140 |
| Ia.144 | CF(Cl₂) | H | — | 3-Cl, 4-Cl | 145-146 |
| Ia.145 | CF(Cl₂) | H | — | 3-Cl, 4-F | 70-71 |
| Ia.146 | CF(Cl₂) | H | — | 3-F, 4-F | 123-124 |
| Ia.147 | CF(Cl₂) | H | — | 3-Cl, 5-Cl | 107-108 |
| Ia.148 | CF(Cl₂) | H | — | 2-Cl, 4-Cl | 121-123 |
| Ia.149 | CF₃ | H | 4-CH₃ | 3-Cl, 4-Cl | 155-160 |
| Ia.150 | CF₃ | H | 4-CH₃ | 2-Cl, 4-Cl | 167-172 |
| Ia.151 | CF₃ | H | 4-CH₃ | 3-F, 4-F | 137-142 |
| Ia.152 | CHF₂ | H | 4-CH₃ | 3-Cl, 4-Cl | 95-98 |
| Ia.153 | CHF₂ | H | 4-CH₃ | 2-Cl, 4-Cl | 165-170 |
| Ia.154 | CHF₂ | H | 4-CH₃ | 3-F, 4-F | 148-152 |
| Ia.155 | CF₃ | H | 5-F | 2-Cl, 4-Cl | 127-131 |
| Ia.156 | CHF₂ | H | 5-F | 2-Cl, 4-Cl | 122-128 |
| Ia.157 | CF₃ | H | — | 3-(OCH₃) | |
| Ia.158 | CF₃ | H | 6-F | 3-Cl, 4-Cl | 67-72 |
| Ia.159 | CF₃ | H | 6-F | 2-Cl, 4-Cl | 142-146 |
| Ia.160 | CHF₂ | H | 6-F | 3-Cl, 4-Cl | 152-155 |
| Ia.161 | CHF₂ | H | 6-F | 2-Cl, 4-Cl | 133-137 |
| Ia.162 | CF₃ | H | 6-F | 3-F, 4-F | 189-191 |
| Ia.163 | CHF₂ | H | 6-F | 3-F, 4-F | 184-186 |
| Ia.164 | CF₃ | H | — | 3-CN | 76-78 |
| Ia.165 | CF₃ | H | — | 3-NO₂ | 84-87 |
| Ia.166 | CF₃ | H | — | 4-NO₂ | 184-185 |
| Ia.167 | CF₃ | H | — | 2-(OCH₃) | 117-118 |
| Ia.168 | CF₃ | H | — | 3-(OCHF₂) | |
| Ia.169 | CF₃ | H | — | 4-(OCHF₂) | 174-175 |
| Ia.170 | CF₃ | H | — | 4-(OCF₃) | 194-196 |
| Ia.171 | CF₃ | H | — | 4-(OCF₂—CHF₂) | 185-186 |
| Ia.172 | CF₃ | H | — | 3-(SCF₃) | 56-59 |
| Ia.173 | CF₃ | H | — | 4-(SCF₃) | 173-174 |
| Ia.174 | CF₃ | H | — | 2-SCH₃ | 134-135 |
| Ia.175 | CF₃ | H | — | 3-SCH₃ | 94-96 |
| Ia.176 | CF₃ | H | — | 4-SCH₃ | 195-196 |
| Ia.177 | CF₃ | H | — | 3-CH₃, 5-CH₃ | |
| Ia.178 | CF₃ | H | — | 3-NO₂, 4-Cl | |
| Ia.179 | CF₃ | H | — | 3-CF₃, 5-CF₃ | |
| Ia.180 | CF₃ | H | — | 3-F, 5-CF₃ | |
| Ia.181 | CF₃ | H | — | 3-CH₃, 4-CH₃ | |
| Ia.182 | CF₃ | H | — | 3-CF₃, 4-Cl | |
| Ia.183 | CF₃ | H | — | 3-CF₃, 4-NO₂ | |
| Ia.184 | CF₃ | H | — | 3-CH₃, 4-OCH₃ | |
| Ia.185 | CF₃ | H | — | 3-OCH₃, 4--OCH₃ | |
| Ia.186 | CF₃ | H | — | 3-F, 4-OCH₃ | |
| Ia.187 | CF₃ | H | — | 3-OCH₃, 4-Cl | |
| Ia.188 | CH₃ | H | 4-F | 3-Cl, 4-Cl | 156-157 |
| Ia.189 | CF₃ | H | — | 3-F, 4-(CH═N—OCH₃) | 180-182 |
| Ia.190 | CHF₂ | H | — | 3-F, 4-(CH═N—OCH₃) | 180-182 |
| Ia.191 | CF₃ | H | — | 3-Cl, 4-CH₃ | |
| Ia.192 | CF₃ | H | — | 2-Cl, 5-CF₃ | |
| Ia.193 | CF₃ | H | — | 3-CF₃, 4-F | |
| Ia.194 | CF₃ | H | — | 2-OCH₃, 5-F | |
| Ia.195 | CF₃ | H | — | 2-F, 5-CH₃ | |
| Ia.196 | CF₃ | H | — | 2-Cl, 5-NO₂ | |
| Ia.197 | CF₃ | H | — | 2-CH₃, 5-Cl | |
| Ia.198 | CF₃ | H | — | 2-F, 4-CH₃ | |
| Ia.199 | CF₃ | H | — | 2-CH₃, 4-NO₂ | |
| Ia.200 | CF₃ | H | — | 2-CH₃, 4-CH₃ | |
| Ia.201 | CF₃ | H | — | 2-CH₃, 4-OC₂H₅ | |
| Ia.202 | CF₃ | H | — | 2-NO₂, 4-Cl | |
| Ia.203 | CF₃ | H | — | 2-NO₂, 4-CH₃ | |
| Ia.204 | CF₃ | H | — | 2-NO₂, 4-OCH₃ | |
| Ia.205 | CF₃ | H | — | 2-NO₂, 4-NO₂ | |
| Ia.206 | CF₃ | H | — | 2-CH₃, 4-OCH₃ | |
| Ia.207 | CF₃ | H | — | 2-CH₃, 3-CH₃ | |
| Ia.208 | CF₃ | H | — | 2-CH₃, 3-NO₂ | |
| Ia.209 | CH₂F | H | — | 3-F, 4-F, 5-F | 152-156 |
| Ia.210 | CF₂—Cl | H | — | 3-F, 4-F, 5-F | 158-161 |
| Ia.211 | CHF—Cl | H | — | 3-F, 4-F, 5-F | 154-157 |
| Ia.212 | CHF₂ | H | — | 3-F, 4-F, 5-F | 156-159 |
| Ia.213 | CF₃ | H | — | 2-NO₂ | 118-119 |
| Ia.214 | CF₃ | H | — | 3-CN, 4-OCH₃ | 184-187 |
| Ia.215 | CHF₂ | H | — | 3-CN, 4-OCH₃ | 152-154 |
| Ia.216 | CF₃ | H | — | 3-OCH₃, 4-CN | 234-236 |
| Ia.217 | CHF₂ | H | — | 3-OCH₃, 4-CN | 188-190 |
| Ia.218 | CF₃ | F | — | 4-CF₃ | 170-173 |
| Ia.219 | CH₃ | Cl | — | 4-CF₃ | 173-175 |
| Ia.220 | CH₃ | H | — | 4-CF₃ | 174-177 |
| Ia.221 | CH₂F | H | — | 4-CF₃ | 156-158 |
| Ia.222 | CF₂—Cl | H | — | 4-CF₃ | 193-196 |
| Ia.223 | CHF—Cl | H | — | 4-CF₃ | 118-186 |
| Ia.224 | CH₂F | H | — | — | 179-181 |
| Ia.225 | CH₂F | H | — | 3-F, 4-Cl | 172-174 |
| Ia.226 | CH₂F | H | — | 2-F, 4-Cl | 111-114 |
| Ia.227 | CH₂F | H | — | 2-F, 3-F, 4-F | 126-129 |
| Ia.228 | CH₂F | H | — | 2-F, 4-F, 5-F | 133-136 |
| Ia.229 | CHF₂ | H | — | 2-F, 3-F, 4-F | 138-140 |
| Ia.230 | CH₂F | H | — | 3-Cl | 96-99 |
| Ia.231 | CHF₂ | H | — | 3-Cl | 110-112 |
| Ia.232 | CH₂F | H | — | 2-Cl | 162-165 |
| Ia.233 | CHF₂ | H | — | 2-Cl | 170-173 |
| Ia.234 | CF₃ | H | — | 2-Cl | 135-139 |
| Ia.235 | CH₂F | H | — | 3-F | 138-141 |
| Ia.236 | CHF₂ | H | — | 3-F | 130-135 |
| Ia.237 | CH₂F | H | — | 2-F | 169-173 |
| Ia.238 | CF₃ | H | — | 2-F | 150-154 |
| Ia.239 | CH₂F | H | — | 2-F, 4-F | 100-102 |
| Ia.240 | CH₂F | H | — | 2-Cl, 4-F | 104-106 |
| Ia.241 | CHF₂ | H | — | 2-Cl, 4-F | 120-124 |
| Ia.242 | CF₃ | H | — | 2-Cl, 4-F | 128-131 |
| Ia.243 | CH₂F | H | — | 3-F, 5-F | 111-115 |
| Ia.244 | CHF₂ | H | — | 3-F, 5-F | 125-127 |
| Ia.245 | CF₃ | H | — | 3-F, 5-F | 142-146 |
| Ia.246 | CHF₂ | H | — | 2-F | 166-169 |
| Ia.247 | CHF₂ | H | 4-F | 3-Cl, 4-F | 137-138 |
| Ia.248 | CHF₂ | H | 5-F | 3-Cl, 4-F | 149-151 |
| Ia.249 | CHF₂ | H | 6-F | 3-Cl, 4-F | 181-182 |
| Ia.250 | CHF₂ | H | — | 3-Cl, 5-F | 114-118 |
| Ia.251 | CF₃ | H | — | 3-Cl, 5-F | 101-103 |
| Ia.252 | CH₂F | H | — | 3-Cl, 5-F | 97-100 |
| Ia.253 | CH₂F | H | — | 2-Cl, 5-Cl | 123-125 |
| Ia.254 | CHF₂ | H | — | 2-Cl, 5-Cl | 130-132 |
| Ia.255 | CF₃ | H | — | 2-Cl, 5-Cl | 131-135 |
| Ia.256 | CH₂F | H | — | 2-F, 5-Cl | 137-139 |
| Ia.257 | CHF₂ | H | — | 2-F, 5-Cl | 148-150 |
| Ia.258 | CF₃ | H | — | 2-F, 5-Cl | 117-120 |
| Ia.259 | CH₂F | H | — | 2-F, 6-F | 168-172 |
| Ia.260 | CHF₂ | H | — | 2-F, 6-F | 129-132 |
| Ia.261 | CH₂F | H | — | 2-Cl, 6-F | 127-130 |
| Ia.262 | CHF₂ | H | — | 2-Cl, 6-F | 118-122 |
| Ia.263 | CF₃ | H | — | 2-Cl, 6-F | 116-119 |
| Ia.264 | CH₂F | H | — | 2-Cl, 5-F | |
| Ia.265 | CHF₂ | H | — | 2-Cl, 5-F | 118-120 |
| Ia.266 | CF₃ | H | — | 2-Cl, 5-F | |
| Ia.267 | CHF₂ | H | — | 2-Cl, 6-Cl | 148-150 |
| Ia.268 | CF₃ | H | — | 2-Cl, 6-Cl | 135-137 |
| Ia.269 | CH₂F | H | — | 2-Cl, 6-Cl | 137-139 |
| Ia.270 | CF₃ | H | — | 2-C₂H₅ | 105-108 |
| Ia.271 | CF₃ | H | — | 3-F, 4-CH₃ | 139-141 |
| Ia.272 | CF₃ | H | — | 2-OC₂H₅ | 100-103 |
| Ia.273 | CF₃ | H | — | 2-(OCH₂—C₂H₅) | 84-86 |
| Ia.274 | CF₃ | H | — | 2-(OCH₂CH₂—C₂H₅) | 81-83 |
| Ia.275 | CF₃ | H | — | 2-[OCH(CH₃)₂] | 86-89 |
| Ia.276 | CHF₂ | H | — | 2-C₂H₅ | 108-110 |
| Ia.277 | CH₃ | F | — | 2-CH₃ | 108-110 |
| Ia.278 | CH₃ | F | — | 2-NO₂ | 148-151 |
| Ia.279 | CH₃ | F | — | 2-Cl | 107-111 |
| Ia.280 | CH₃ | F | — | 2-CF₃ | 110-112 |
| Ia.281 | CH₃ | F | — | 2-F, 4-CH₃ | 123-126 |
| Ia.282 | CH₃ | F | — | 2-CH₃, 4-Cl | 132-136 |
| Ia.283 | CH₃ | F | — | 2-CH₃, 4-F | 146-149 |
| Ia.284 | CH₃ | F | — | 2-F, 4-OCH₃ | 130-132 |
| Ia.285 | CH₃ | F | — | 2-F, 4-Cl | 133-136 |
| Ia.286 | CH₃ | F | — | 2-F, 5-CN | 143-145 |
| Ia.287 | CH₃ | F | — | 2-F, 5-OCH₃ | 94-97 |
| Ia.288 | CH₃ | F | — | 2-F, 5-Cl | 100-102 |
| Ia.289 | CH₃ | F | — | 2-Cl, 5-Cl | 123-124 |
| Ia.290 | CH₃ | F | — | 2-CH₃, 5-NO₂ | 117-118 |
| Ia.291 | CH₃ | F | — | 2-CH₃, 5-CH₃ | 96-97 |
| Ia.292 | CH₃ | F | — | 3-CF₃, 5-CF₃ | 156-158 |
| Ia.293 | CH₃ | F | — | 3-F, 5-CH₃ | 116-117 |
| Ia.294 | CH₃ | F | — | 3-F, 5-CN | 168-170 |
| Ia.295 | CH₃ | F | — | 3-CH₃, 5-CH₃ | 152-154 |
| Ia.296 | CH₃ | F | — | 3-CN | 137-138 |
| Ia.297 | CH₃ | F | — | 3-NO₂ | 137-139 |
| Ia.298 | CH₃ | F | — | 3-CF₃ | 113-114 |
| Ia.299 | CF₃ | H | — | 2-OCH₃, 4-F | 120-121 |
| Ia.300 | CF₃ | H | — | 3-NO₂, 4-OCH₃ | 170-172 |
| Ia.301 | CF₃ | H | — | 3-Cl, 4-OCH₃ | 140-145 |
| Ia.302 | CF₃ | H | — | 2-F, 5-OCH₃ | 128-129 |
| Ia.303 | CF₃ | H | — | 2-OCH₃, 5-[CH(CH₃)₂] | 127-129 |
| Ia.304 | CH₃ | H | — | 2-CHF₂ | 134-135 |
| Ia.305 | CHF₂ | H | — | 2-CHF₂ | 131-133 |
| Ia.306 | CF₃ | F | — | 2-CHF₂ | 126-128 |
| Ia.307 | CF₃ | F | — | 2-C₂H₅ | 110-112 |
| Ia.308 | CH₃ | H | — | 2-C₂H₅ | 116-118 |
| Ia.309 | CF₃ | F | — | 2-CH₃ | 111-112 |
| Ia.310 | CF₃ | F | — | 2-OCH₃ | 121-123 |
| Ia.311 | CHF₂ | H | — | 2-OCH₃ | 97-99 |
| Ia.312 | CH₃ | H | — | 2-OCH₃ | 94-96 |
| Ia.313 | CHF₂ | H | — | 4-(SCF₃) | 134-137 |

Among the above compounds Ia, preference is given to compounds Ia.43, Ia.44, Ia.45, Ia.57, Ia.64, Ia.84, Ia.85, Ia.90, Ia.110, Ia.173, Ia.211, Ia.219, Ia.230, Ia.231, Ia.233, Ia.244, Ia.245, Ia.249, Ia.250, Ia.251, Ia.255 and Ia.313. More preference is given to compounds Ia.85, Ia.90, Ia.110, Ia.245 and Ia.255. Particularly preferred compounds Ia are compounds Ia.90 and Ia.110.

A further embodiment of the present invention relates to compounds of the formula Ib

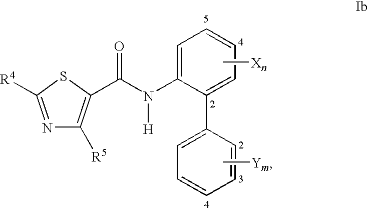

wherein X, Y, m, n, R¹, R² and R³ are as defined herein. Amongst compounds Ib, preference is given to those, wherein m is zero to three and n is zero or one. Compounds Ib depicted in the following Table 2 are very particularly preferred:

TABLE 2

| Com- | | | | | m.p. |
|---|---|---|---|---|---|
| pound | R⁴ | R⁵ | Xₙ | Yₘ | [° C.] |
| Ib.1 | CH₃ | CF₃ | — | — | 116-118 |
| Ib.2 | CH₃ | CH₃ | — | — | 136-137 |
| Ib.3 | H | CH₃ | — | — | 66-68 |
| Ib.4 | H | CF₃ | — | — | 102-106 |
| Ib.5 | CH₃ | CH₃ | — | 4-Cl | 119-122 |
| Ib.6 | CH₃ | CH₃ | — | 4-OCH₃ | 92-94 |
| Ib.7 | CH₃ | CH₃ | — | 2-OCH₃ | 90-91 |
| Ib.8 | CH₃ | CF₃ | — | 4-OCH₃ | 83-86 |
| Ib.9 | CH₃ | CF₃ | — | 4-Cl | 122-125 |
| Ib.10 | CH₃ | CF₃ | — | 2-OCH₃ | |
| Ib.11 | CH₃ | CF₃ | — | 4-F | 112-114 |
| Ib.12 | CH₃ | CF₃ | — | 2-CH₃ | |
| Ib.13 | CH₃ | CF₃ | — | 3-Cl | 137-139 |
| Ib.14 | CH₃ | CH₃ | — | 4-F | 122-124 |
| Ib.15 | CH₃ | CH₃ | — | 2-CH₃ | |
| Ib.16 | CH₃ | CH₃ | — | 3-Cl | |
| Ib.17 | CH₃ | CF₂—Cl | — | — | 143-145 |
| Ib.18 | CH₃ | CHF₂ | — | — | 84-86 |
| Ib.19 | CH₃ | CF₃ | — | 3-CH₃ | |
| Ib.20 | CH₃ | CF₃ | — | 3-F | 94-95 |
| Ib.21 | CH₃ | CF₃ | — | 4-CH₃ | 76-79 |
| Ib.22 | CH₃ | CF₃ | — | 4-CH(CH₃)₂ | 165-166 |
| Ib.23 | CH₃ | CF₃ | — | 4-C(CH₃)₃ | 169-170 |
| Ib.24 | CH₃ | CH₃ | — | 4-C(CH₃)₃ | 151-153 |
| Ib.25 | CH₃ | CF₃ | 4-F | 4-F | 136-138 |
| Ib.26 | CH₃ | CF₃ | 4-F | 4-CH₃ | 106-108 |
| Ib.27 | CH₃ | CF₃ | 4-F | 4-Cl | 144-146 |
| Ib.28 | CH₃ | CF₃ | 4-F | — | 146-148 |
| Ib.29 | CH₃ | CF₃ | 5-F | 4-F | 108-110 |
| Ib.30 | CH₃ | CF₃ | 3-F | 4-F | 118-120 |
| Ib.31 | CH₃ | CF₃ | 3-F | 4-Cl | 123-124 |
| Ib.32 | CH₃ | CF₃ | — | 2-Cl, 4-Cl | 111-115 |
| Ib.33 | CH₃ | CF₃ | — | 3-Cl, 4-F | 112-115 |
| Ib.34 | CH₃ | CF₃ | — | 3-Cl, 4-Cl | 100-102 |
| Ib.35 | CH₃ | CF₃ | — | 3-F, 4-F | 121-123 |
| Ib.36 | CH₃ | CF₃ | — | 3-Cl, 5-Cl | 126-128 |
| Ib.37 | CH₃ | CHF₂ | — | 2-Cl, 4-Cl | 101-104 |
| Ib.38 | CH₃ | CHF₂ | — | 3-Cl, 5-Cl | |
| Ib.39 | CH₃ | CHF₂ | — | 3-F, 4-F | 81-84 |
| Ib.40 | CH₃ | CHF₂ | — | 3-Cl, 4-Cl | |
| Ib.41 | CH₃ | CHF₂ | — | 3-Cl, 4-F | |
| Ib.42 | CH₃ | CF₃ | — | 3-CH₃, 5-CH₃ | |
| Ib.43 | CH₃ | CF₃ | — | 3-NO₂, 4-Cl | |
| Ib.44 | CH₃ | CF₃ | — | 3-CF₃, 5-CF₃ | |
| Ib.45 | CH₃ | CF₃ | — | 3-F, 5-CF₃ | |
| Ib.46 | CH₃ | CF₃ | 5-F | 2-F, 4-Cl, 5-OCH₃ | |
| Ib.47 | CH₃ | CHF₂ | 5-F | 2-F, 4-Cl, 5-OCH₃ | 134-137 |
| Ib.48 | CH₃ | CH₃ | 5-F | 2-F, 4-Cl, 5-OCH₃ | |
| Ib.49 | CH₃ | CF₃ | 4-F, 6-Cl | 2-F, 4-Cl, 5-CH₃ | 150-153 |
| Ib.50 | CH₃ | CHF₂ | 4-F, 6-Cl | 2-F, 4-Cl, 5-CH₃ | 154-157 |
| Ib.51 | CH₃ | CH₃ | 4-F, 6-Cl | 2-F, 4-Cl, 5-CH₃ | |
| Ib.52 | CH₃ | CF₃ | 5-F | 3-F, 4-F | 112-116 |
| Ib.53 | CH₃ | CHF₂ | 5-F | 3-F, 4-F | 120-122 |
| Ib.54 | CH₃ | CH₃ | 5-F | 3-F, 4-F | |
| Ib.55 | CH₃ | CF₃ | 4-F, 6-Cl | 3-F, 4-F | |
| Ib.56 | CH₃ | CHF₂ | 4-F, 6-Cl | 3-F, 4-F | |
| Ib.57 | CH₃ | CH₃ | 4-F, 6-Cl | 3-F, 4-F | 170-174 |
| Ib.58 | CH₃ | CF₃ | — | 3-F, 4-F, 5-F | 148-152 |
| Ib.59 | CH₃ | CF₃ | — | 2-F, 4-F, 5-F | 112-116 |
| Ib.60 | CH₃ | CH₃ | — | 3-F, 4-F, 5-F | 123-128 |
| Ib.61 | CH₃ | CH₃ | — | 2-F, 4-F, 5-F | 150-154 |
| Ib.62 | CH₃ | CF₃ | — | 3-CF₃ 4-NO₂ | |
| Ib.63 | CH₃ | CF₃ | — | 3-CH₃, 4-OCH₃ | |
| Ib.64 | CH₃ | CF₃ | — | 3-OCH₃, 4-OCH₃ | |
| Ib.65 | CH₃ | CF₃ | — | 3-F, 4-OCH₃ | |
| Ib.66 | CH₃ | CHF₂ | — | 4-CF₃ | 145-147 |
| Ib.67 | CH₃ | CHF₂ | — | 3-F, 4-Cl | 112-114 |
| Ib.68 | CH₃ | CHF₂ | — | 4-Cl | 147-149 |
| Ib.69 | CH₃ | CF₃ | — | 3-F, 4-Cl | 143-144 |
| Ib.70 | CH₃ | CHF₂ | — | 4-Br | 152-153 |
| Ib.71 | CH₃ | CF₃ | — | 3-Cl, 4-CH₃ | |
| Ib.72 | CH₃ | CF₃ | — | 3-CH₃, 4-Cl | |
| Ib.73 | CH₃ | CF₃ | — | 3-CH₃, 4-F | |
| Ib.74 | CH₃ | CF₃ | — | 3-CF₃, 4-F | |
| Ib.75 | CH₃ | CF₃ | — | 2-F, 4-CH₃ | |
| Ib.76 | CH₃ | CF₃ | — | 2-CH₃, 4-NO₂ | |
| Ib.77 | CH₃ | CF₃ | — | 2-CH₃, 4-CH₃ | |
| Ib.78 | CH₃ | CF₃ | — | 2-CH₃, 4-OC₂H₅ | |
| Ib.79 | CH₃ | CF₃ | — | 2-NO₂, 4-Cl | |
| Ib.80 | CH₃ | CF₃ | — | 2-NO₂, 4-OCH₃ | |
| Ib.81 | CH₃ | CF₃ | — | 2-NO₂, 4-NO₂ | |
| Ib.82 | CH₃ | CF₃ | — | 3-CN | 138-140 |
| Ib.83 | CH₃ | CF₃ | — | 4-CN | 169-171 |
| Ib.84 | CH₃ | CF₃ | — | 3-NO₂ | 136-140 |
| Ib.85 | CH₃ | CF₃ | — | 4-NO₂ | 199-201 |
| Ib.86 | CH₃ | CF₃ | — | 3-OCH₃ | 92-93 |
| Ib.87 | CH₃ | CF₃ | — | 3-OCHF₂ | 85-86 |
| Ib.88 | CH₃ | CF₃ | — | 4-OCHF₂ | 119-120 |
| Ib.89 | CH₃ | CF₃ | — | 4-OCF₃ | 148-149 |
| Ib.90 | CH₃ | CF₃ | — | 3-OCF₃ | 82-84 |
| Ib.91 | CH₃ | CF₃ | — | 4-OCF₂—CHF₂ | 147-148 |
| Ib.92 | CH₃ | CF₃ | — | 3-SCF₃ | 125-126 |
| Ib.93 | CH₃ | CF₃ | — | 4-SCF₃ | 138-140 |
| Ib.94 | CH₃ | CF₃ | — | 2-SCH₃ | |
| Ib.95 | CH₃ | CF₃ | — | 3-SCH₃ | 104-105 |
| Ib.96 | CH₃ | CF₃ | — | 4-SCH₃ | 141-142 |
| Ib.97 | CH₃ | CF₃ | — | 2-NO₂ | 120-121 |
| Ib.98 | CH₃ | CF₃ | — | 3-CN, 4-OCH₃ | 183-184 |
| Ib.99 | CH₃ | CF₃ | — | 3-OCH₃, 4-CN | 150-152 |

A further embodiment of the present invention relates to compounds of the formula Ic

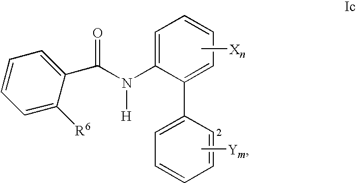

wherein X, Y, m, n, R¹, R² and R³ are as defined herein. Amongst compounds Ic, preference is given to those, wherein m is zero to three and n is zero or one. Compounds Ic depicted in the following Table 3 are very particularly preferred:

TABLE 3

| Compound | R⁶ | Xₙ | Yₘ | m.p. [° C.] |
|---|---|---|---|---|
| Ic.1 | Cl | — | 2-OCH₃ | |
| Ic.2 | Iodine | — | 3-Cl, 4-Cl | 141-144 |
| Ic.3 | Iodine | — | 3-F, 4-F | 113-117 |
| Ic.4 | CF₃ | — | 3-Cl, 4-Cl | 108-111 |
| Ic.5 | CF₃ | — | 3-Cl, 4-F | 100-103 |

A further embodiment of the present invention relates to compounds of the formula Id

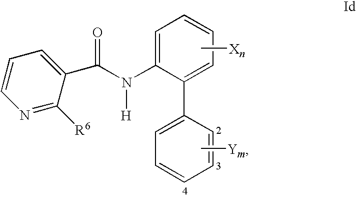

wherein X, Y, m, n, R¹, R² and R³ are as defined herein. Amongst compounds Id, preference is given to those, wherein m is zero to three, preferably 1 to 3, more preferably 1 or 2 and in particular 1, and n is zero or one. Compounds Id depicted in the following Table 4 are very particularly preferred:

TABLE 4

| Compound | R⁶ | Xₙ | Yₘ | m.p. [° C.] |
|---|---|---|---|---|
| Id.1 | Cl | — | 4-Cl | 147-148 |
| Id.2 | Cl | — | 3-Cl, 4-Cl | 125-127 |
| Id.3 | Cl | — | 3-Cl, 5-Cl | 147-149 |
| Id.4 | Cl | — | 3-Cl, 4-F | 144-145 |
| Id.5 | Cl | — | 3-F, 4-F | 123-125 |
| Id.6 | Cl | — | 2-Cl, 4-Cl | 105-109 |
| Id.7 | CF₃ | — | 3-Cl, 4-Cl | 150-153 |
| Id.8 | Cl | — | 2-F, 5-F | 74-75 |
| Id.9 | Cl | — | 2-F, 4-Cl | 124-126 |
| Id.10 | Cl | — | 2-CH₃, 4-Cl | 122-123 |
| Id.11 | Cl | — | 3-CH₃, 4-Cl | 111-113 |
| Id.12 | Cl | — | 2-CH₃, 4-F | 95-97 |
| Id.13 | Cl | — | 3-CH₃, 4-F | 92-93 |
| Id.14 | Cl | — | 3-F, 4-Cl | 113-115 |
| Id.15 | Cl | — | 2-F, 4-F | 117-118 |
| Id.16 | Cl | — | 4-CN | 172-174 |
| Id.17 | Cl | — | 2-F, 4-OCH₃ | 110-112 |
| Id.18 | Cl | 5-F | 2-Cl, 4-Cl | 150-155 |
| Id.19 | Cl | — | 3-F, 4-F, 5-F | 139-144 |
| Id.20 | Cl | — | 2-F, 4-F, 5-F | 103-110 |
| Id.21 | Cl | — | 2-F, 4-Cl, 5-(OCH₃) | 159-162 |
| Id.22 | CF₃ | 5-F | 2-Cl, 4-Cl | 164-169 |
| Id.23 | CF₃ | — | 3-F, 4-F, 5-F | 164-168 |
| Id.24 | CF₃ | — | 2-F, 4-F, 5-F | 141-144 |
| Id.25 | CF₃ | — | 2-F, 4-Cl, 5-(OCH₃) | 151-156 |
| Id.26 | CF₃ | — | 3-F, 4-F | 121-125 |
| Id.27 | CF₃ | — | 3-Cl, 5-Cl | 161-165 |
| Id.28 | CF₃ | — | 2-Cl, 4-Cl | 143-147 |
| Id.29 | CF₃ | — | 4-F, 5-Cl | 167-170 |
| Id.30 | Cl | — | 3-NO₂, 4-Cl | |
| Id.31 | Cl | — | 3-CF₃, 5-CF₃ | |
| Id.32 | Cl | — | 3-F, 5-CF₃ | |
| Id.33 | Cl | — | 3-CH₃, 4-CH₃ | |
| Id.34 | Cl | — | 3-CF₃, 4-NO₂ | |
| Id.35 | Cl | — | 3-CH₃, 4-OCH₃ | |
| Id.36 | Cl | — | 3-OCH₃, 4-OCH₃ | |
| Id.37 | Cl | — | 3-CH₃, 4-OH | |
| Id.38 | Cl | — | 3-F, 4-OCH₃ | |
| Id.39 | CF₃ | — | 4-CF₃ | 148-151 |
| Id.40 | CF₃ | — | 3-CF₃ | 124-127 |
| Id.41 | CF₃ | — | 2-CF₃ | 170-173 |
| Id.42 | Cl | — | 3-CF₃ | 140-142 |
| Id.43 | Cl | — | 2-CF₃ | 109-112 |
| Id.44 | Cl | — | 3-Cl, 4-CH₃ | |
| Id.45 | Cl | — | 2-NO₂, 4-Cl | |
| Id.46 | Cl | — | 2-NO₂, 4-NO₂ | |
| Id.47 | CF₃ | — | — | 138-148 |
| Id.48 | Cl | — | 3-CN | 164-166 |
| Id.49 | Cl | — | 3-NO₂ | 152-154 |
| Id.50 | Cl | — | 4-NO₂ | 196-198 |
| Id.51 | Cl | — | 3-OCH₃ | 84-86 |
| Id.52 | Cl | — | 3-OCHF₂ | 125-127 |
| Id.53 | Cl | — | 4-OCHF₂ | 135-139 |
| Id.54 | Cl | — | 3-OCF₃ | 130-131 |
| Id.55 | Cl | — | 4-OCF₃ | 162-163 |
| Id.56 | Cl | — | 4-OCF₂—CHF₂ | 118-120 |
| Id.57 | Cl | — | 3-SCF₃ | 147-149 |
| Id.58 | Cl | — | 4-SCF₃ | 145-149 |
| Id.59 | Cl | — | 2-SCH₃ | 118-120 |
| Id.60 | Cl | — | 3-SCH₃ | 90-92 |
| Id.61 | Cl | — | 4-SCH₃ | 152-153 |
| Id.62 | Cl | — | 2-NO₂ | 124-129 |
| Id.63 | Cl | — | 3-CN, 4-OCH₃ | 188-190 |
| Id.64 | Cl | — | 3-OCH₃, 4-CN | 154-155 |

Particularly preferred compounds Id are compounds Id.1, Id.55, Id.56 and Id.58, Id.1 being more preferred.

Among compounds I, those are preferred wherein Ar is a group IIa or IIc, wherein Z is preferably N. More preferred are compounds Ia, among these compounds Ia.43, Ia.44, Ia.45, Ia.57, Ia.64, Ia.84, Ia.85, Ia.90, Ia.110, Ia.173, Ia.211, Ia.219, Ia.230, Ia.231, Ia.233, Ia.244, Ia.245, Ia.249, Ia.250, Ia.251, Ia.255 and Ia.313 being particularly preferred, compounds Ia.85, Ia.90, Ia.110, Ia.245 and Ia.255 being more preferred and compounds Ia.90 and Ia.110 being even more preferred, and compounds Id, compounds Id.1, Id.55, Id.56 and Id.58 and specifically Id.1 being among these particularly preferred.

As used herein, the term “seed” denotes any resting stage of a plant that is physically detached from the vegetative stage of a plant and/or may be stored for prolonged periods of time and/or can be used to re-grow another plant individual of the same species.

Here, the term “resting” refers to a state wherein the plant retains viability, within reasonable limits, in spite of the absence of light, water and/or nutrients essential for the vegetative (i.e. non-seed) state. In particular, the term refers to true seeds but does not embraces plant propagules such as suckers, corms, bulbs, fruit, tubers, cuttings and cut shoots.

As used herein, the term “plant” means an entire plant or parts thereof. The term “entire plant” refers to a complete plant individual in its vegetative, i.e. non-seed stage, characterized by the presence of an arrangement of roots, shoots and foliage, depending on the developmental stage of the plant also flowers and/or fruits, all of which are physically connected to form an individual which is, under reasonable conditions, viable without the need for artificial measures. The term may also refer to an entire plant harvested as such.

The term “plant parts” refers to roots, shoots, foliage, flowers or other parts of the vegetative stage of the plant, which, when dislodged and disconnected from the rest, are incapable of survival, unless supported by artificial measures or able to re-grow the missing parts to form an entire plant. As used herein, fruits are also considered as plant parts.

As used herein, the term “root” refers to parts of a plant which are normally, in order to fulfill their physiological functions, located beneath the soil surface. Preferably, the term denotes the parts of a plant which are below the seed and have directly emerged from the latter, or from other roots, but not from shoots or foliage.

As used herein, the “shoots and foliage” of a plant are to be understood to be the shoots, stems, branches, leaves and other appendages of the stems and branches of the plant after the seed has sprouted, but not including the roots of the plant. It is preferable that the shoots and foliage of a plant be understood to be those non-root parts of the plant that have grown from the seed and are located a distance of at least one inch away from the seed from which they emerged (outside the region of the seed), and more preferably, to be the non-root parts of the plant that are at or above the surface of the soil.

As used herein, “fruits” are considered to be the parts of a plant which contain seeds and/or serve to spread seeds, and/or which may be removed from a plant without impairing its viability.

According to the present invention, the seed treatment comprises applying an arylcarb-oxylic acid biphenylamide of the formula (I) to a seed. The seed may be from naturally occurring plants, from plants obtained by means of classical breeding or from genetically modified plants, for example glyphosate tolerant soybean plants.

Although the present method can be applied to a seed in any physiological state, it is preferred that the seed be in a sufficiently durable state that it incurs no significant damage during the treatment process. Typically, the seed is a seed that has been harvested from the field; removed from the plant; and/or separated from the fruit and any cob, pod, stalk, outer husk, and surrounding pulp or other non-seed plant material. The seed is preferably also biologically stable to the extent that the treatment would cause no biological damage to the seed. In one embodiment, for example, the treatment can be applied to seed that has been harvested, cleaned and dried to a moisture content below about 15% by weight. In an alternative embodiment, the seed can be one that has been dried and then primed with water and/or another material and then re-dried before or during the treatment with the arylcarboxylic acid biphenylamide of formula (I).

In a further embodiment, the seed can be one from genetically modified plants, in particular soybean plants.

The term seed treatment comprises all suitable seed treatment and especially seed dressing techniques known in the art, such as seed coating (e.g. seed pelleting), seed dusting and seed imbibition (e.g. seed soaking). Here, “seed treatment” refers to all methods that bring seeds and the arylcarboxylic acid biphenylamide of formula (I) into contact with each other, and “seed dressing” to methods of seed treatment which provide the seeds with an amount of the arylcarboxylic acid biphenylamide of formula (I), i.e. which generate a seed comprising the arylcarboxylic acid biphenylamide of formula (I). In principle, the treatment can be applied to the seed at any time from the harvest of the seed to the sowing of the seed. The seed can be treated immediately before, or during, the planting of the seed, for example using the “planter's box” method. However, the treatment may also be carried out several weeks or months, for example up to 12 months, before planting the seed, for example in the form of a seed dressing treatment, without a substantially reduced efficacy being observed.

Expediently, the treatment is applied to unsown seed. As used herein, the term “unsown seed” is meant to include seed at any period from the harvest of the seed to the sowing of the seed in the ground for the purpose of germination and growth of the plant.

When it is said that unsown seed is “treated”, such treatment is not meant to include those practices in which the fungicide is applied to the soil, rather than directly to the seed. Indeed, it is believed that the treatment of the soil, or more generally of the growth medium, into which the seed is sowed affords the same protecting effect on the plant that grows from the seed: Without wishing to be bound by theory, it is presumed that the prophylactic effect of the arylcarboxylic acid biphenylamide I on the plant which grows from the seed treated according to the invention is at least partly based on the migration of the active compound from the sowed seed to the surrounding growth medium from where it is taken up by the developing root. Once in the plant, it confers resistance against fungal pathogens. Accordingly, the treatment of the growing medium should have a comparable effect. Nevertheless, soil treatment is not encompassed by the method or the use according to the invention because it exposes the farmers to the fungicides I.

By applying the treatment to the seed prior to the sowing of the seed the operation is simplified. In this manner, seeds can be treated, for example, at a central location and then dispersed for planting. This permits the person who plants the seeds to avoid the handling and use of the arylcarboxylic acid biphenylamide of formula I and to merely handle and plant the treated seeds in a manner that is conventional for regular untreated seeds, which reduces human exposure.

In each embodiment of the invention, it is preferred that the arylcarboxylic acid biphenylamide of formula (I) is applied to a seed in an effective amount, that is, an amount sufficient to provide protection against phytopathogenic fungi to the plant that grows from the seed. Of course, not only the plant, but also the treated seed is protected by the method according to the invention from fungal attack. The arylcarboxylic acid biphenylamides of formula (I) are not only effective against seed fungi, but also against soilborne and foliar phytopathogenic fungi.

As used herein, “protection” is achieved if the percent of damage to the seed and/or the plant at 10 days after infestation (DAI) with the fungus is significantly reduced for treated seeds or plants grown from treated seeds as compared to untreated seeds or plants grown from untreated seeds. In order to be effective, the arylcarboxylic acid biphenylamide of formula I is generally employed in an amount of from 1 to 500 g, preferably 10 to 200 g, per 100 kilograms of seed.

According to the present invention one purpose of said seed treatment is to control phytopathogenic fungi. Such a seed treatment thus involves a fungicidal effect or a fungicidal activity providing protection against damage done by the fungus to a plant grown from the seed. Of course, the seed treatment also provides protection against damage done by the fungus to the seed.

As used herein, the terms “fungicidal effect” and “fungicidal activity” mean any direct or indirect action on the target pathogen (which may be any fungus, but includes according to the invention rust infections on leguminous plants and their seed) that results in reduction of damage on the treated seeds and, surprisingly, also on the fruits, roots, shoots and/or foliage, in particular on the overground part of the plants, such as fruits, shoots and in particular foliage, of plants grown from treated seeds as compared to untreated seeds or to plants grown from untreated seeds, respectively. The terms “active against a (first or second) pathogen” also have the same meaning. Such direct or indirect actions include killing of the fungal pathogen, inhibiting infestation of the fungal pathogen on the plant seeds, fruits, roots, shoots and/or foliage, and inhibiting or preventing reproduction of the fungal pathogen.

The method and the use according to the invention are for protecting a plant after germination, i.e. after the hypocotyl with cotyledons or shoot has broken through the seed coat. Preferably, the method and the use according to the invention are for protecting a plant after emergence, i.e. after the coleoptil or the cotyledons or the shoot or the leaf breaks through the soil surface. Even more preferably, the method and the use according to the invention are for protecting a plant which is in the growth stage 09 (according to the BBCH extended scale; German Federal Biological Research Centre for Agriculture and Forestry; see www.bba.de/veroeff/bbch/bbcheng.pdf) or a later growth stage. Preferably, the plant is to be protected after its emergence and before flowering (principal growth stages 0 to 5), more preferably after emergence and before inflorescence emergence (principal growth stage 0 to 4) and even more preferably after emergence and before the development of harvestable vegetative plant parts or vegetatively propagated organs/booting (principal growth stage 0 to 3). In case the plant to be protected is a leguminous plant, in particular soybean, preferably it is to be protected when it is in the growth stage 09 to 49, more preferably in the growth stage 09 to 39, and even more preferably in the growth stage 09 to 29. In case the plant is a cereal, in particular wheat, preferably it is to be protected when it is in the growth stage 09 to 59, more preferably in the growth stage 09 to 49, and even more preferably in the growth stage 09 to 39. The two-digit growth stages refer to the BBCH extended scale, while the one-digit growth stages are the principal growth stages.

The target organisms for the present invention are foliar phytopathogenic fungi, i.e. fungi which attack the overground part of the plant and in particular the leaves. However, the use or the method according to the invention also provides protection from soilborne or seed pathogens.

The target organisms for the present invention are preferably fungal diseases in leguminous plants, in particular soybeans. The most important fungal pathogens are:

Microsphaera diffusa,

Cercospora kikuchi,

Cercospora sojina,

Septoria glycines,

Colletotrichum truncatum,

Phakopsora pachyrhizi and Phakopsora meibomiae.

Phakopsora pachyrhizi and Phakopsora meibomiae represent particular target pathogens of the present invention.

In an alternative preferred embodiment, the target organisms for the present invention are fungal diseases in cereals. Cereals in the proper sense are cultivated forms of grasses (pocaceae) and include for example wheat (inclusive spelt, einkorn, emmer, kamut, durum and triticale), rye, barley, rice, wild rice, maize (corn), millet, sorghum, teff and oats. In the present invention, the term “cereals”, however, also includes pseudocereals. These are broadleaf plants (non-grasses) that can be used the same way as true cereals. For example, their seed can be ground into flour and otherwise used as cereals are. Examples of pseudocereals are amaranth, quinoa and buckwheat. The most important cereal fungal pathogens are:
Alternaria ssp.,
Ascochyta tritici,
Blumeria graminis,
Botrytis cinerea,
Cladosporium herbarum,
Cochliobolus sativus,
Cochliobolus miyabeanus,
Drechslera maydis,
Drechslera teres,
Drechslera tritici-repentis,
Epicoccum spp.,
Erysiphe graminis,
Fusarium culmorum,
Fusarium graminearum,
Gaeumanomyces graminis,
Gibberella fujikuroi,
Michrodochium nivale,
Mycosphaerella graminicola,
Pseudocercosporella herpotrichoides,
Puccinia graminis,
Puccinia hordei,
Puccinia recondita,
Puccinia striformins,
Pyrenophora teres,
Puccinia frifticina,

Pyrenophora tritici-repentis
Pyricularia grisae,
Rhizoctonia cerealis,
Rhynchosporium secalis,
Septoria nodorum,
Septoria tritici,
Stagonospora nodorum,
Typhula incarnate.

Erysiphe graminis, Septoria trifici and Puccinia recondita represent particular target cereal pathogens of the present invention.

The present seed treatment can be used to control said target pests and/or to protect the seeds, roots and/or the above-ground parts of field, forage, plantation, glasshouse, orchard or vineyard crops, ornamentals, plantation or forest trees and/or any other plant(s) of interest. The seeds that are useful in the present invention can be the seeds of any plant species.

However, the seed is preferably of a tuberous or corn vegetable, a leafy vegetable, a leafy brassica green, a fruiting vegetable, a leguminous plant or a cereal. Accordingly, the plant to be protected is preferably a tuberous or corn vegetable, a leafy vegetable, a leafy brassica green, a fruiting vegetable, a leguminous plant or a cereal.

Preferred tuberous vegetables are beetroot, carrot, cassaya, potato, and radish.

Preferred leafy vegetables are chicory, endive, lettuce, radicchio and spinach.

Preferred leafy brassica green are broccoli, Brussels sprout, cabbage, cauliflower and kale.

Preferred fruiting vegetables are cucumber, eggplant, avocado, pumpkin, tomato and cucurbit.

Preferred legumes are those of agricultural use, such as beans, peas, chickpeas, lentils, soybeans and peanuts, soybeans being particularly preferred.

Preferred cereals are cereals in the proper sense (=cultivated forms of grasses (pocaceae)), such as wheat (inclusive spelt, einkorn, emmer, kamut, durum and triticale), rye, barley, rice, wild rice, maize (corn), millet, sorghum, teff and oats, and also pseudocereals, such as amaranth, quinoa and buckwheat. More preferred cereals are wheat and barley, particularly preferred being wheat.

In a particularly preferred embodiment of the invention, the seed to be treated according to the invention is a soybean seed. Accordingly, in a particularly preferred embodiment, the plant to be protected after germination is soybean.

The soybean can be a non-transgenic plant, e.g. as obtained by traditional breeding, or can have at least one transgenic event. In one embodiment it is preferred that the soybean plant be a transgenic plant having preferably a transgenic event that confers resistance to a pesticide, preferably for the herbicide glyphosate. Accordingly, it is preferred that the transgenic plant be one having a transgenic event that provides glyphosate resistance. Some examples of such preferred transgenic plants having transgenic events that confer glyphosate resistance are described in U.S. Pat. No. 5,914,451, U.S. Pat. No. 5,866,775, U.S. Pat. No. 5,804,425, U.S. Pat. No. 5,776,760, U.S. Pat. No. 5,633,435, U.S. Pat. No. 5,627,061, U.S. Pat. No. 5,463,175, U.S. Pat. No. 5,312,910, U.S. Pat. No. 5,310,667, U.S. Pat. No. 5,188,642, U.S. Pat. No. 5,145,783, U.S. Pat. No. 4,971,908 and U.S. Pat. No. 4,940,835. More preferably, the transgenic soybean plant has the characteristics of “Roundup-Ready” transgenic soybeans (available from Monsanto Company, St. Louis, Mo.).

It is to be understood, however, that when the soybean plant is a transgenic plant, the transgenic events that are present in the plant are by no means limited to those that provide pesticide resistance, but can include any transgenic event. In fact, the use of “stacked” transgenic events in a plant is also contemplated.

In an alternative, particularly preferred embodiment of the invention, the seed to be treated according to the invention is a wheat seed. Accordingly, in a particularly preferred embodiment, the plant to be protected after germination is wheat.

As used herein, ingredients comprise active ingredients and auxiliary agents.

In the present invention, an “active ingredient” is a compound or a combination of compounds which directly exerts a biologically relevant effect, preferably a fungicidal effect as described above.

To widen the spectrum of action, the active ingredient, i.e. the arylcarboxylic acid biphenylamide of formula (I), can also be employed together with other active ingredients which are useful in seed treatment, for example together with fungicides, insecticides, molluscicides, nematicides, herbicides, algicides, bactericides, rodenticides, bird/mammal repellents, growth regulators, safener or also fertilizers.

The following list of active ingredients with which the arylcarboxylic acid biphenylamide of formula (I) can be used in accordance with the invention is intended to illustrate the possible combinations, but not to impose any limitation:

Fungicides:
(1.1) azoles such as bromoconazole, cyproconazole, difenoconazole, epoxiconazole, fluquinconazole, flusilazole, flutriafol, hexaconazole, imazalil, metconazole, myclobutanil, penconazole, propiconazole, prochloraz, prothioconazole, tebuconazole, tetraconazole, triadimefon, triadimenol, and triticonazole;
(1.2) acylalanines such as benalaxyl, metalaxyl, mefenoxam, ofurace and oxadixyl;
(1.3) amine derivatives such as guazatine;
(1.4) anilinopyrimidines such as pyrimethanil, mepanipyrim and cyprodinil;
(1.5) dicarboximides such as iprodione, procymidone, vinclozolin;
(1.6) dithiocarbamates such as mancozeb, metiram and thiram;
(1.7) heterocylic compounds such as benomyl, carbendazim, carboxin, oxycarboxin, fuberidazole, picobenzamid, penthiopyrad, proquinazid, thiabendazole and thiophanate-methyl;
(1.8) phenylpyrroles such as fenpiclonil and fludioxonil;
(1.9) other fungicides, for example benthiavalicarb, cyflufenamid, fosetyl, fosetyl-aluminium, phosphorous acid and its salts, iprovalicarb and metafenone;
(1.10) strobilurins such as azoxystrobin, dimoxystrobin, enestrobin, enestroburin, fluoxastrobin, kresoxim-methyl, metominostrobin, orysastrobin, picoxystrobin, pyraclostrobin, trifloxystrobin, methyl (2-chloro-5-[1-(3-methylbenzyloxyimino)-ethyl]benzyl)carbamate, methyl (2-chloro-5-[1-(6-methylpyridin-2-ylmethoxy-imino)ethyl]benzyl)carbamate and methyl 2-ortho-[(2,5-dimethylphenyloxy-methylene)phenyl]-3-methoxyacrylate;
(1.11) cinnamides and analogous compounds such as dimethomorph, flumetover and flumorph;

Insecticides/Acaricides:
(2.1) organo(thio)phosphates selected from acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos and trichlorfon;
(2.2) carbamates selected from alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb and triazamate;
(2.3) pyrethroids selected from allethrin, bifenthrin, cycloprothrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, flucythrinate, imiprothrin, lambda-cyhalothrin, gamma-cyhalothrin, permethrin, prallethrin, pyrethrin I and II, resmethrin, silafluofen, tau-fluvalinate, tefluthrin, tetramethrin, tralomethrin, transfluthrin and profluthrin, dimefluthrin;
(2.4) growth regulators selected from a) chitin synthesis inhibitors that are selected from the benzoylureas bistrifluoron, chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole and clofentazine; b) ecdysone antagonists that are selected from halofenozide, methoxyfenozide, tebufenozide and azadirachtin; c) juvenoids that are selected from pyriproxyfen, methoprene and fenoxycarb and d) lipid biosynthesis inhibitors that are selected from spirodiclofen, spiromesifen and spirotetramat;
(2.5) nicotinic receptor agonist/antagonist compounds selected from clothianidin, dinotefuran, imidacloprid, thiamethoxam, nitenpyram, acetamiprid, thiacloprid;
(2.6) GABA antagonist compounds selected from acetoprole, endosulfan, ethiprole, fipronil, vaniliprole,
(2.7) macrocyclic lactone insecticides selected from abamectin, emamectin, milbemectin, lepimectin and spirosad;
(2.8) METI I compounds selected from fenazaquin, pyridaben, tebufenpyrad, tolfenpyrad and flufenerim;
(2.9) METI II and III compounds selected from acequinocyl, fluacyprim and hydramethylnon;
(2.10) uncoupler compounds: chlorfenapyr; (2.11) oxidative phosphorylation inhibitor compounds selected from cyhexatin, diafenthiuron, fenbutatin oxide and propargite;
(2.12) moulting disruptor compounds: cyromazine;
(2.13) mixed function oxidaes inhibitor compounds: piperonyl butoxide;
(2.14) sodium channel blocker compounds selected from metaflumizone and indoxacarb;
(2.15) a compound selected from benclothiaz, bifenazate, cartap, flonicamid, pyridalyl, pymetrozine, sulfur, thiocyclam, flubendiamide, cyenopyrafen, flupyrazofos, cyflumetofen, amidoflumet, the aminoisothiazole compound of formula Γ¹

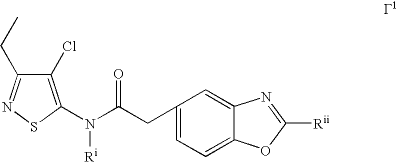

wherein Rⁱ is —CH₂OCH₂CH₃ or H and Rⁱⁱ is CF₂CF₂CF₃ or CH₂C(CH₃)₃; anthranilamide compounds of formula Γ²

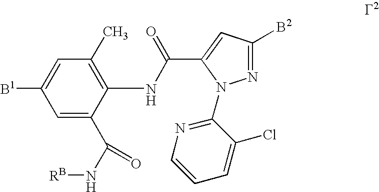

wherein B¹ is hydrogen, CN or C¹, B² is Br or CF₃, and R^{B} is hydrogen, CH₃ or CH(CH₃)₂;
and malonitrile compounds as described in JP 2002-284608, WO 02/89579, WO 02/90320, WO 02/90321, WO 04/06677, WO 04/20399 or JP 2004-99597.
Molluscicides;
Nematicides;
Herbicides, for example imidazolinone herbicides such as imazethapyr, imazamox, imazapyr and imazapic, or dimethenamid-p;
Algicides;
Bactericides;
Biologicals;
Bird/mammal repellents;
Fertilizers;
Fumigants;
Growth regulators;
Rodenticides.

Molluscicides, nematicides, herbicides, algicides, bactericides, biologicals, bird/mammal repellents, fertilizers, fumigants, growth regulators and rodenticides are well known to a person skilled in the art.

According to a particular embodiment, the arylcarboxylic acid biphenylamides of formula (I) are used in combination with an azole fungicide, in particular epoxyconazole, fluquinconazole, flutriafole, Ipconazole, prothioconazole or triticonazole.

According to another particular embodiment, the arylcarboxylic acid biphenylamides of formula (I) are used in combination with at least one insecticide. The at least one insecticide is preferably selected from the group consisting of acetamiprid, alpha-cypermethrin, beta-cypermethrin, bifenthrin, carbofuran, carbosulfan, clothianidin, cycloprothrin, cyfluthrin, cypermethrin, deltamethrin, diflubenzuron, dinotefuran, etofenprox, fenbutatin-oxide, fenpropathrin, fipronil, flucythrinate, imidacloprid, lambda-cyhalothrin, nitenpyram, pheromones, spinosad, teflubenzuron, tefluthrin, terbufos, thiacloprid, thiamethoxam, thiodicarb, tralomethrin, triazamate, zeta-cypermethrin, spirotetramat, flupyrazofos, tolfenpyrad, flubendiamide, bistrifluoron, benclothiaz, pyrafluprole, pyriprole, amidoflumet, flufenerim, cyflumetofen, cyenopyrafen, the anthranilamide compound of formula Γ² where B¹ is C¹, B² is Br and R^{B} is CH₃, and the anthranilamide compound of formula Γ² where B¹ is CN, B² is Br and R^{B} is CH₃.

Preferred insecticides are GABA antagonist compounds, herein preferred being fipronil, and nicotinic receptor agonist/antagonist compounds, herein preferred being clothianidin, imidacloprid and thiamethoxam. A particularly preferred insecticide is fipronil.

If the arylcarboxylic acid biphenylamides of formula (I) are employed jointly with a further active ingredient, especially with an azole fungicide and/or fipronil, the ratio by weight of the arylcarboxylic acid biphenylamides of formula (I) to the amount of the further active ingredient(s) is usually in the range of 1:100 to 100:1, preferably in the range of 1:50 to 50:1, and in particular in the range of 1:10 to 10:1.

If an arylcarboxylic acid biphenylamide of formula (I) is employed jointly with a further active ingredient, the latter can be applied simultaneously with the arylcarboxylic acid biphenylamide of formula (I) or after a short time interval, for example within a few days before or after the treatment with the arylcarboxylic acid biphenylamide of formula (I). In the case of simultaneous application, the treatment of the seed can be effected in one pass where a composition comprising the arylcarboxylic acid biphenylamides of formula (I) and the further active ingredient is applied, or else in separate passes where different formulations of the individual active ingredients are applied.

The active ingredient concentrations in ready-to-use preparations can be varied within substantial ranges. In general, they are between in the range from 0.01 and 80% by weight, frequently in the range from 0.1 to 50% by weight, preferably in the range from 0.5 and 20% by weight, based on the total weight of the preparation. The active ingredients can also successfully be used in concentrated form, it being possible to apply, to the seed, preparations with more than 80% by weight of active ingredient, or even the active ingredient without additions. The amount of additives will generally not exceed 30% by weight, preferably 20% by weight, and is, in particular, in the range of from 0.1 to 20% by weight, in each case based on the total weight of the preparation.

In principle, all customary methods of treating and in particular dressing such as coating (e.g. pelleting) and imbibing (e.g. soaking) seeds can be employed. Specifically, the seed treatment follows a procedure in which the seed is exposed to the specifically desired amount of a preparation comprising the arylcarboxylic acid biphenylamide of formula I. The preparation may be a formulation that is applied as such or after previously diluting it, e.g. with water; for instance, it may be expedient to dilute seed treatment formulations 2-10 fold leading to concentrations in the ready-to-use compositions of 0.01 to 60% by weight active compound by weight, preferably 0.1 to 40% by weight.

Usually, a device which is suitable for this purpose, for example a mixer for solid or solid/liquid components, is employed until the preparation is distributed uniformly on the seed. Thus, the preparation can be applied to seeds by any standard seed treatment methodology, including but not limited to mixing in a container (e.g., a bottle, bag or tumbler), mechanical application, tumbling, spraying, and immersion. If appropriate, this is followed by drying.

Particular embodiments of the present invention comprise seed coating and imbibition (e.g. soaking). “Coating” denotes any process that endows the outer surfaces of the seeds partially or completely with a layer or layers of non-plant material, and “imbibition” any process that results in penetration of the active ingredient(s) into the germinable parts of the seed and/or its natural sheath, (inner) husk, hull, shell, pod and/or integument. The invention therefore also relates to a treatment of seeds which comprises providing seeds with a coating that comprises an arylcarboxylic acid biphenylamide of formula (I), and to a treatment of seeds which comprises imbibition of seeds with an arylcarboxylic acid biphenylamide of formula I.

Coating is particularly effective in accommodating high loads of the arylcarboxylic acid biphenylamide of formula (I), as may be required to treat typically refractory fungal pathogens, while at the same time preventing unacceptable phytotoxicity due to the increased load of the arylcarboxylic acid biphenylamide of formula I.

Coating may be applied to the seeds using conventional coating techniques and machines, such as fluidized bed techniques, the roller mill method, rotostatic seed treaters, and drum coaters. Other methods such as the spouted beds technique may also be useful. The seeds may be pre-sized before coating. After coating, the seeds are typically dried and then transferred to a sizing machine for sizing.

Such procedures are known in the art. Seed coating methods and apparatus for their application are disclosed in, for example, U.S. Pat. No. 5,918,413, U.S. Pat. No. 5,891,246, U.S. Pat. No. 5,554,445, U.S. Pat. No. 5,389,399, U.S. Pat. No. 5,107,787, U.S. Pat. No. 5,080,925, U.S. Pat. No. 4,759,945 and U.S. Pat. No. 4,465,017.

In another particular embodiment, the solid the arylcarboxylic acid biphenylamide of formula I, for instance as a solid fine particulate formulation, e.g. a powder or dust, can be mixed directly with seeds. Optionally, a sticking agent can be used to adhere the solid, e.g. the powder, to the seed surface. For example, a quantity of seed can be mixed with a sticking agent (which increases adhesion of the particles on the surface of the seed) and optionally agitated to encourage uniform coating of the seed with the sticking agent. For example, the seed can be mixed with a sufficient amount of sticking agent, which leads to a partial or complete coating of the seed with sticking agent. The seed pretreated in this way is then mixed with a solid formulation containing the arylcarboxylic acid biphenylamide of formula I to achieve adhesion of the solid formulation on the surface of the seed material. The mixture can be agitated, for example by tumbling, to encourage contact of the sticking agent with the solid arylcarboxylic acid biphenylamide, thereby causing the solid the arylcarboxylic acid biphenylamide I to stick to the seed.

Another particular method of treating seed with the arylcarboxylic acid biphenylamide of formula I is imbibition. For example, seed can be combined for a period of time with an aqueous solution comprising from about 1% by weight to about 75% by weight of the arylcarboxylic acid biphenylamide of formula I in a solvent such as water. Preferably the concentration of the solution is from about 5% by weight to about 50% by weight, more preferably from about 10% by weight to about 25% by weight. During the period in which the seed is combined with the solution, the seed takes up (imbibes) at least a portion of the arylcarboxylic acid biphenylamide of formula I. Optionally, the mixture of seed and solution can be agitated, for example by shaking, rolling, tumbling, or other means. After the imbibition process, the seed can be separated from the solution and optionally dried in a suitable manner, for example by patting or air-drying.

In yet another particular embodiment of the present invention, the arylcarboxylic acid biphenylamide of formula I can be introduced onto or into a seed by use of solid matrix priming. For example, a quantity of the arylcarboxylic acid biphenylamide of formula I can be mixed with a solid matrix material, and then the seed can be placed into contact with the solid matrix material for a period to allow the arylcarboxylic acid biphenylamide of formula I to be introduced to the seed. The seed can then optionally be separated from the solid matrix material and stored or used, or, preferably, the mixture of solid matrix material plus seed can be stored or planted/sown directly.

As described above, the arylcarboxylic acid biphenylamide of formula I and optionally the further active ingredient(s) can be used as such, that is, without any auxiliary agents present. However, the arylcarboxylic acid biphenylamide of formula I and the further active ingredient(s) are typically applied to the seeds in the form of a composition.

As used herein, a “composition” comprises at least one active ingredient and at least one auxiliary agent.

The term “auxiliary agent” refers to a compound or combination of compounds which do not exert a biologically relevant effect of their own, but support the effects of the active ingredient(s). When auxiliary agents are used, their choice will depend on the active ingredients and on the procedures selected for seed treatment.

Usually, the compositions thus comprise an active ingredient component (“A”) and an auxiliary agent component (“B”). The active ingredient component (“A”) of the composition comprises the arylcarboxylic acid biphenylamide of formula I (“A1”) and optionally one or more further active ingredient(s) (“A2”). The auxiliary agent component (“B”) comprises one or more auxiliary agent(s).

In general, the compositions comprise from 0.005% by weight to 95% by weight, preferably from 0.1% by weight to 90% by weight, in particular from 5% by weight to 50% by weight, of the active ingredient component “A”, the balance being formed by component “B”. In this context, the active ingredients are employed in a purity of 90% to 100%, preferably 95% to 100% (according to NMR spectrum). According to a particular embodiment, component “A” essentially consists of the arylcarboxylic acid biphenylamide of formula I, i.e. the active ingredient of the composition is the arylcarboxylic acid biphenylamide of formula I.

In a particular embodiment of the invention, the composition may additionally comprise one or more repellents for warm-blooded animals, e.g. birds, dogs and hedgehogs, for example nonanoic acid vanillyl amide. The amount of repellent will preferably range from 0.1 to 5% by weight, based on the total weight of the composition.

According to a particular embodiment, the composition is a seed treatment formulation. A seed treatment formulation according to the present invention comprises at least one auxiliary agent that is specifically suited for the seed treatment, i.e. an auxiliary agent which in particular promotes adhesion of the arylcarboxylic acid biphenylamide of formula I to and/or penetration into the seeds and/or otherwise improves stability and/or manageability of the composition or the seeds treated therewith. Thus, the present invention also relates to a seed treatment formulation, which comprises the arylcarboxylic acid biphenylamide of formula I, at least one seed treatment auxiliary agent(s), and optionally one or more further auxiliary agents.

In particular, seed treatment auxiliary agents are selected from the group consisting of agents suitable for seed coating materials, agents suitable for solid matrix priming materials, penetration enhancers suitable for promoting seed imbibition, colorants, antifreezes, and gelling agents.

According to a preferred embodiment, the seed coating material comprises a binder (or sticker). Optionally, the coating material also comprises one or more additional seed treatment auxiliary agents selected from the group consisting of fillers and plasticizers.

Binders (or stickers) are all customary binders (or stickers) which can be employed in seed treatment formulations. Binders (or stickers) that are useful in the present invention preferably comprise an adhesive polymer that may be natural or partly or wholly synthetic and is without phytotoxic effect on the seed to be coated. Preferably, the binder (or sticker) is biodegradable. Preferably the binder or sticker is chosen to act as a matrix for the arylcarboxylic acid biphenylamide of formula I.

The binder (or sticker) may be selected from polyesters, polyether esters, polyanhydrides, polyester urethanes, polyester amides; polyvinyl acetates; polyvinyl acetate copolymers; polyvinyl alcohols and tylose; polyvinyl alcohol copolymers; polyvinylpyrolidones; polysaccharides, including starches, modified starches and starch derivatives, dextrins, maltodextrins, alginates, chitosanes and celluloses, cellulose esters, cellulose ethers and cellulose ether esters including ethylcelluloses, methylcelluloses, hydroxymethylcelluloses, hydroxypropylcelluloses and carboxymethylcellulose; fats; oils; proteins, including casein, gelatin and zeins; gum arabics; shellacs; vinylidene chloride and vinylidene chloride copolymers; lignosulfonates, in particular calcium lignosulfonates; polyacrylates, polymethacrylates and acrylic copolymers; polyvinylacrylates; polyethylene oxide; polybutenes, polyisobutenes, polystyrene, polyethyleneamines, polyethylenamides; acrylamide polymers and copolymers; polyhydroxyethyl acrylate, methylacrylamide monomers; and polychloroprene. In a particular embodiment, the binder is a thermoplastic polymer.

In a particular embodiment of the invention the seed treatment formulation contains at least one polyester, which, in particular, is selected from polylactides, partially aromatic polyesters (copolymers of terephthalic acid, adipic acid and aliphatic diols), polyglycolides, polyhydroxyalkanoates and polytartrates.

The amount of binder (or sticker) in the formulation can vary, but will be in the range of about 0.01 to about 25% of the total weight, more preferably from about 1 to about 15%, and even more preferably from about 5% to about 10%.

As mentioned above, the coating material can optionally also comprise a filler. The filler can be an absorbent or an inert filler, such as are known in the art, and may include wood flours, cereal flours, tree bark mill, wood meal and nut shell meal, sugars, in particular polysaccharides, activated carbon, fine-grain inorganic solids, silica gels, silicates, clays, chalk, diatomaceous earth, calcium carbonate, magnesium carbonate, dolomite, magnesium oxide, calcium sulfate and the like. Clays and inorganic solids which may be used include calcium bentonite, kaolin, china clay, talc, perlite, mica, vermiculite, silicates, quartz powder, montmorillonite, attapulgite, bole, loess, limestone, lime and mixtures thereof. Sugars which may be useful include dextrin and maltodextrin. Cereal flours include wheat flour, oat flour and barley flour. The filler may also comprise fertilizer substances such as, for example, ammonium sulfate, ammonium phosphate, ammonium nitrate, ureas and mixtures thereof.

The filler is selected so that it will provide a proper microclimate for the seed, for example the filler is used to increase the loading rate of the active ingredients and to adjust the control-release of the active ingredients. The filler can aid in the production or process of coating the seed. The amount of filler can vary, but generally the weight of the filler components will be in the range of about 0.05 to about 75% of the total weight, more preferably about 0.1 to about 50%, and even more preferably about 0.5% to 15%.

It is preferred that the binder (or sticker) be selected so that it can serve as a matrix for the arylcarboxylic acid biphenylamide of formula I. While the binders disclosed above may all be useful as a matrix, it is preferred that a continuous solid phase of one or more binder compounds is formed throughout which is distributed as a discontinuous phase the arylcarboxylic acid biphenylamide of formula I. Optionally, a filler and/or other components can also be present in the matrix. The term “matrix” is to be understood to include what may be viewed as a matrix system, a reservoir system or a microencapsulated system. In general, a matrix system consists of the arylcarboxylic acid biphenylamide of formula I and a filler uniformly dispersed within a polymer, while a reservoir system consists of a separate phase comprising the arylcarboxylic acid biphenylamide of formula (I) or its salt that is physically dispersed within a surrounding, rate-limiting, polymeric phase. Microencapsulation includes the coating of small particles or droplets of liquid, but also to dispersions in a solid matrix.

Especially if the arylcarboxylic acid biphenylamide of formula I used in the coating is an oily type composition and little or no inert filler is present, it may be useful to hasten the drying process by drying the composition. This optional step may be accomplished by means well known in the art and can include the addition of calcium carbonate, kaolin or bentonite clay, perlite, diatomaceous earth, or any absorbent material that is added preferably concurrently with the arylcarboxylic acid biphenylamide of formula I coating layer to absorb the oil or excess moisture. The amount of absorbent necessary to effectively provide a dry coating will be in the range of about 0.5 to about 10% of the weight of the seed.

Optionally, the coating material comprises a plasticizer. Plasticizers are typically used to make the film that is formed by the coating layer more flexible, to improve adhesion and spreadability, and to improve the speed of processing. Improved film flexibility is important to minimize chipping, breakage or flaking during storage, handling or sowing processes. Many plasticizers may be used; however, useful plasticizers include polyethylene glycol, oligomeric polyalkylene glycols, glycerol, alkylbenzylphthalates, in particular butylbenzylphthalate, glycol benzoates and related compounds.

The amount of plasticizer in the coating layer will be in the range of from about 0.1% by weight to about 20% by weight.

Agents suitable for solid matrix priming materials which are useful in the present invention include polyacrylamide, starch, clay, silica, alumina, soil, sand, polyurea, polyacrylate, or any other material capable of absorbing or adsorbing the arylcarboxylic acid biphenylamide of formula I for a time and releasing that arylcarboxylic acid biphenylamide of formula I into or onto the seed. It is useful to make sure that the arylcarboxylic acid biphenylamide of formula I and the solid matrix material are compatible with each other. For example, the solid matrix material should be chosen so that it can release the arylcarboxylic acid biphenylamide of formula I at a reasonable rate, for example over a period of minutes, hours, or days.

Penetration enhancers suitable for promoting seed imbibition include agriculturally acceptable surface active compounds. The amount of penetration enhancers will usually not exceed 20% by weight, based on the total weight of the formulation. Preferably, the amount of penetration enhancers will be in the range from 2% to 20% by weight.

Colorants according to the invention are all dyes and pigments which are customary for such purposes. In this context, both pigments, which are sparingly soluble in water, and dyes, which are soluble in water, may be used. Examples which may be mentioned are the colorants, dyes and pigments known under the names Rhodamin B, C. I. Pigment Red 112 and C. I. Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108. The amount of colorants will usually not exceed 20% by weight of the formulation and preferably ranges from 1 to 15% by weight, based on the total weight of the formulation. It is generally preferred if the colorants are also active as repellents for warm-blooded animals, e.g. iron oxide, TiO₂, Prussian blue, anthraquinone dyes, azo dyes and metal phtalocyanine dyes.

Antifreezes which can be employed especially for aqueous formulations are in principle all those substances which lead to a depression of the melting point of water. Suitable antifreezes comprise alcohols such as methanol, ethanol, isopropanol, butanols, glycol, glycerine, diethylenglycol and the like. Typically, the amount of antifreeze will not exceed 20% by weight and frequently ranges from 1 to 15% by weight, based on the total weight of the formulation.

Gelling agents which are suitable are all substances which can be employed for such purposes in agrochemical compositions, for example cellulose derivatives, polyacrylic acid derivatives, xanthan, modified clays, in particular organically modified phyllosilicates and highly-dispersed silicates. A particularly suitable gelling agent is carrageen (Satiagel®). Usually, the amount of gelling agent will not exceed 5% by weight of the formulation and preferably ranges from 0.5 to 5% by weight, based on the total weight of the formulation.

Further auxiliary agents that may be present in the seed treatment formulation include solvents, wetters, dispersants, emulsifiers, surfactants, stabilizers, protective colloids, antifoams, and preservatives.

Examples of suitable solvents are water or organic solvents such as aromatic solvents (for example Solvesso® products, xylene), paraffins (for example mineral oil fractions), alcohols (for example methanol, butanol, pentanol, benzyl alcohol), ketones (for example cyclohexanone, gamma-butyrolactone), pyrrolidones (N-methylpyrrolidone, N-octylpyrrolidone), acetates (glycol diacetate), glycols, fatty acid dimethylamides, fatty acids and fatty acid esters. In principle, solvent mixtures may also be used. However, according to a particular embodiment, the formulations of the present invention contain less than 10% by weight and preferably less than 6% by weight of said organic solvents.

Surface active compounds are all those surfactants which are suitable for formulating agrochemical actives, in particular for the arylcarboxylic acid biphenylamide of formula I, and which may be nonionic, cationic, anionic or amphoteric. According to their action, surfactants—sometimes referred to as “additives”—may be divided into wetters, dispersants, emulsifiers or protective colloids; however, these particular groups may overlap and cannot be divided strictly. Typically, the amount of surfactants will not exceed 20% by weight and frequently ranges from 1 to 15% by weight, based on the total weight of the formulation.

Suitable wetters are all those substances which promote wetting and which are conventionally used for formulating agrochemical active ingredients. Alkylnaphthalenesulfonates such as diisopropyl- or diisobutylnaphthalenesulfonates can be used preferably.

Dispersants and/or emulsifiers which are suitable are all nonionic, anionic and cationic dispersants or emulsifiers conventionally used for formulating agrochemical active ingredients. The following can preferably be used: nonionic or anionic dispersants and/or emulsifiers or mixtures of nonionic or anionic dispersants and/or emulsifiers.

Suitable nonionic dispersants and/or emulsifiers which may be employed are, in particular, ethylene oxide/alkylene oxide block copolymers, alkylphenol polyglycol ethers and tristyrylphenol polyglycol ethers, for example polyoxyethylene octylphenol ether, ethoxylated isooctylphenol, octylphenol, nonylphenol, alkylphenol polyglycol ether, tributylphenyl polyglycol ether, tristearylphenyl polyglycol ether, alkylaryl-polyether alcohols, alcohol and fatty alcohol ethylene oxide condensates, ethoxylated castor oil, polyoxyethylene alkyl ether, ethoxylated polyoxypropylene, lauryl alcohol polyglycol ether acetal, sorbitol esters and methyl cellulose. However, according to a particular embodiment, the formulations of the present invention contain less than 10% by weight and preferably less than 6% by weight of ethylene oxide/alkylene oxide block copolymer, and, more particularly, less than 10% by weight and preferably less than 6% by weight of said nonionic dispersants and/or emulsifiers.

Suitable anionic dispersants which and/or emulsifiers which may be employed are, in particular, alkali metal, alkaline earth metal and ammonium salts of ligninsulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore arylsulfonate/formaldehyde condensates, for example condensates of sulfonated naphthalene and naphthalene derivatives with formaldehyde, condensates of naphthalene or of naphthalenesulfonic acid with phenol and formaldehyde, ligninsulfonates, lignin-sulfite waste liquors, phosphated or sulfated derivatives of methylcellulose, and salts of polyacrylic acid.

Protective colloids are typically water soluble, amphiphilic polymers. Examples include proteins und denatured proteins such as casein, polysaccharides such as water soluble starch derivatives and cellulose derivatives, in particular hydrophobic modified starch and celluloses, furthermore polycarboxylates such as polyacrylic acid and acrylic acid copolymers, polyvinylalcohol, polyvinylpyrrolidone, vinylpyrrolidone copolymers, polyvinyl amines, polyethylene imines and polyalkylene ethers.

Antifoams which can be employed are all those substances which inhibit the development of foam and which are conventionally used for formulating agrochemical active ingredients. Silicone antifoams, i.e. aqueous silicon emulsions (e.g. Silikon® SRE by Wacker or Rhodorsil® by Rhodia), long chain alcohols, fatty acids and salts thereof, e.g. and magnesium stearate are particularly suitable. Usually, the amount of antifoam will not exceed 3% by weight of the formulation and preferably ranges from 0.1 to 2% by weight, based on the total weight of the formulation.

Preservatives which can be employed are all preservatives used for such purposes in agrochemical compositions. Examples which may be mentioned are dichlorophene, isothiazolenes and isothiazolones such as 1,2-benzisothiazol-3(2H)-one, 2-methyl-2H-isothiazol-3-one-hydrochloride, 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one-hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one-calcium chloride complex, 2-octyl-2H-isothiazol-3-one and benzyl alcohol hemiformal. Usually, the amount of preservatives will not exceed 2% by weight of the formulation and preferably ranges from 0.01 to 1% by weight, based on the total weight of the formulation.

The skilled person is essentially familiar with agricultural compositions of active ingredients. Examples include water-soluble concentrates (SL, LS), dispersible concentrates (DC), emulsifiable concentrates (EC), emulsions (EW, EO, ES), suspensions (SC, OD, FS), water-dispersible granules (WG, SG), water-dispersible or water-soluble powders (WP, SP, SS, WS), dusts or dustable powders (DP, DS), granules (GR, FG, GG, MG), ULV solutions (UL) and gel formulations (GF). The skilled worker is familiar with such compositions, for example from Ullmann's Encyclopedia of Industrial Chemistry, Fungicides Chapter 4, 5th ed. on CD-ROM, Wiley-VCH, 1997 and Mollet, H., Grubemann, A., Formulation technology, Wiley VCH Verlag GmbH, Weinheim (Federal Republic of Germany), 2001. For seed treatment purposes, such compositions may be applied as such or after addition of a suitable liquid, in particular water, in order to dissolve, emulsify, disperse, suspend or dilute the composition. The type of the ready-to-use preparation applied to the seeds thus depends on the type of composition used and the method used for treating the seeds.

Such compositions can be prepared in the known manner (see e.g. for review U.S. Pat. No. 3,060,084, EP-A 707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pages 8-57 and et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Germany), 2001, 2. D. A. Knowles, Chemistry and Technology of Agrochemical Formulations, Kluwer Academic Publishers, Dordrecht, 1998 (ISBN 0-7514-0443-8)), for example by extending the active ingredient component with one or more auxiliary agents.

The following examples simply illustrate said compositions:

### A Water-Soluble Concentrates, Solutions (SL, LS)

10 parts by weight of an arylcarboxylic acid biphenylamide I are dissolved in 90 parts by weight of water or a water-soluble solvent. As an alternative, wetters or other auxiliaries are added to the phenylsemicarbazone of formula (I) or the agriculturally acceptable salt thereof. The phenylsemicarbazone of formula (I) or the agriculturally acceptable salt thereof dissolves upon dilution with water, whereby a formulation with 10% (w/w) of the arylcarboxylic acid biphenylamide I is obtained.

### B Dispersible Concentrates (DC)

20 parts by weight of an arylcarboxylic acid biphenylamide I are dissolved in 70 parts by weight of cyclohexanone with addition of 10 parts by weight of a dispersant, for example polyvinylpyrrolidone. Dilution with water gives a dispersion, whereby a formulation with 20% (w/w) of the arylcarboxylic acid biphenylamide I is obtained.

### C Emulsifiable Concentrates (EC)

15 parts by weight of an arylcarboxylic acid biphenylamide I are dissolved in 7 parts by weight of xylene with addition of calcium dodecylbenzenesulfonate and castor oil ethoxylate (in each case 5 parts by weight). Dilution with water gives an emulsion, whereby a formulation with 15% (w/w) of the arylcarboxylic acid biphenylamide I is obtained.

### D Emulsions (EW, EO, ES)

25 parts by weight of an arylcarboxylic acid biphenylamide I are dissolved in 35 parts by weight of xylene with addition of calcium dodecylbenzenesulfonate and castor oil ethoxylate (in each case 5 parts by weight). This mixture is introduced into 30 parts by weight of water by means of an emulsifier machine (e.g. Ultraturrax) and made into a homogeneous emulsion. Dilution with water gives an emulsion, whereby a formulation with 25% (w/w) of the arylcarboxylic acid biphenylamide I is obtained.

### E Suspensions (SC, OD, FS)

In an agitated ball mill, 20 parts by weight of an arylcarboxylic acid biphenylamide I are comminuted with addition of 10 parts by weight of dispersants, wetters and 70 parts by weight of water or of an organic solvent to give a fine active compound(s) suspension. Dilution with water gives a stable suspension of the arylcarboxylic acid biphenylamide 1, whereby a formulation with 20% (w/w) of the arylcarboxylic acid biphenylamide I is obtained.

### F Water-Dispersible Granules (WG, SG)

50 parts by weight of an arylcarboxylic acid biphenylamide I are ground finely with addition of 50 parts by weight of dispersants and wetters and made as water-dispersible or water-soluble granules by means of technical appliances (for example extrusion, spray tower, fluidized bed). Dilution with water gives a stable dispersion or solution of the active compound(s), whereby a formulation with 50% (w/w) of the arylcarboxylic acid biphenylamide I is obtained.

### G Water-Dispersible and Water-Soluble Powders (WP, SP, SS, WS)

75 parts by weight of an arylcarboxylic acid biphenylamide I are ground in a rotor-stator mill with addition of 25 parts by weight of dispersants, wetters and silica gel. Dilution with water gives a stable dispersion or solution of the active compound(s), whereby a formulation with 75% (w/w) of the arylcarboxylic acid biphenylamide I is obtained.

### H Dusts and Dustable Powders (DP, DS)

5 parts by weight of an arylcarboxylic acid biphenylamide I are ground finely and mixed intimately with 95 parts by weight of finely divided kaolin. This gives a dustable product having 5% (w/w) of the arylcarboxylic acid biphenylamide 1.

### J Granules (GR, FG, GG, MG),

0.5 part by weight of an arylcarboxylic acid biphenylamide I is ground finely and associated with 95.5 parts by weight of carriers, whereby a formulation with 0.5% (w/w) of the arylcarboxylic acid biphenylamide I is obtained. Current methods are extrusion, spray-drying or the fluidized bed. This gives granules to be applied undiluted for foliar use.

### K ULV Solution (UL)

10 parts by weight of an arylcarboxylic acid biphenylamide I are dissolved in 90 parts by weight of an organic solvent, for example xylene. This gives a product having 10% (w/w) of the arylcarboxylic acid biphenylamide 1, which is applied undiluted for foliar use.

### L Gel Formulation (GF)

In an agitated ball mill, 20 parts by weight of an arylcarboxylic acid biphenylamide I are comminuted with addition of 10 parts by weight of dispersants, 1 part by weight of a gelling agent wetters and 70 parts by weight of water or of an organic solvent to give a fine active compound(s) suspension. Dilution with water gives a stable suspension of the arylcarboxylic acid biphenylamide 1, whereby a formulation with 20% (w/w) of the arylcarboxylic acid biphenylamide I is obtained.

For the seed treatment according to the present invention, powders, such as water-dispersible, water-soluble and dustable powders, dusts and suspensions are preferred. Further, gel formulations are preferred. Also, water-soluble concentrates and emulsions may be expediently used.

According to the present invention, the following formulations are particularly preferred: flowable concentrates (especially FS); solutions (especially LS); powders for dry treatment (especially DS); water dispersible powders for slurry treatment (especially WS); water-soluble powders (especially SS) and emulsions (especially ES). Also preferred are gel formulations (especially GF). These formulations can be applied to the seed diluted or undiluted.

According to a particular embodiment, a FS formulation is used for seed treatment. Typically, a FS formulation may comprise 1-800 g/l of an arylcarboxylic acid biphenylamide 1, 1-200 g/l surfactant, 0 to 200 g/l antifreezing agent, 0 to 400 g/l of binder, 0 to 200 g/l of a colorant and up to 1 litre of a solvent, preferably water.

According to a further particular embodiment, the seed treatment formulation of the present invention is a seed coating formulation.

Such seed coating formulations comprise an arylcarboxylic acid biphenylamide 1, at least one binder (or sticker) and optionally at least one further auxiliary agent that is selected from the group consisting of fillers and plasticizers.

Seed coating formulations comprising binders, fillers and/or plasticizers are well-known in the art. Seed coating formulations are disclosed, for example, in U.S. Pat. No. 5,939,356, U.S. Pat. No. 5,882,713, U.S. Pat. No. 5,876,739, U.S. Pat. No. 5,849,320, U.S. Pat. No. 5,834,447, U.S. Pat. No. 5,791,084, U.S. Pat. No. 5,661,103, U.S. Pat. No. 5,622,003, U.S. Pat. No. 5,580,544, U.S. Pat. No. 5,328,942, U.S. Pat. No. 5,300,127, U.S. Pat. No. 4,735,015, U.S. Pat. No. 4,634,587, U.S. Pat. No. 4,383,391, U.S. Pat. No. 4,372,080, U.S. Pat. No. 4,339,456, U.S. Pat. No. 4,272,417 and U.S. Pat. No. 4,245,432, among others.

The amount of the arylcarboxylic acid biphenylamide of formula I that is included in the coating formulation will vary depending upon the type of seed, but the coating formulation will contain an amount of arylcarboxylic acid biphenylamide I that is fungicidally effective. In general, the amount of arylcarboxylic acid biphenylamide I in the coating formulation will range from about 0.005 to about 75% of the total weight. A more preferred range for the arylcarboxylic acid biphenylamide I is from about 0.01 to about 40%; more preferred is from about 0.05 to about 20%.

The exact amount of the arylcarboxylic acid biphenylamide I that is included in the coating formulation is easily determined by one skilled in the art and will vary depending upon the size and other characteristics (surface structure etc.) of the seed to be coated. The arylcarboxylic acid biphenylamide I of the coating formulation must not inhibit germination of the seed and should be efficacious in protecting the seed and/or the plant during that time in the target pathogen's life cycle in which it causes injury to the seed or plant. In general, the coating will be efficacious for approximately 0 to 120 days, preferably for approximately 0 to 60 days, after sowing.

The coating formulations formed with the arylcarboxylic acid biphenylamide I are capable of effecting a slow rate of release of the arylcarboxylic acid biphenylamide I by diffusion or movement through the matrix into the seed or to the surrounding medium.

The present invention also provides a seed that has been treated by the method described above. It also provides a seed obtainable by the method described above.

Further, the present invention also provides a seed that has been treated with a seed treatment formulation described above, and in particular that is coated with the formulation or contains it. It also provides a seed obtainable by using the formulation described above.

The term “coated with and/or contains” here signifies that the arylcarboxylic acid biphenylamide I is for the most part on the surface of the seed at the time of application, although a greater or lesser part of the arylcarboxylic acid biphenylamide I may penetrate into the seed, depending on the method of application. When the said seed is (re)planted, it may absorb the arylcarboxylic acid biphenylamide 1.

Still further, the present invention relates to a seed, especially an unsown seed, which comprises an arylcarboxylic acid biphenylamide of formula I.

According to one embodiment, such a seed comprising an arylcarboxylic acid biphenylamide of formula I has a coating, wherein the coating comprises the arylcarboxylic acid biphenylamide I. According to a further embodiment, such a seed comprising the arylcarboxylic acid biphenylamide I is a seed whose germinable part and/or natural sheath, shell, pod and/or integument comprise(s) the arylcarboxylic acid biphenylamide I. Also, the arylcarboxylic acid biphenylamide I can be present in both the coating and the germinable part and/or natural sheath, shell, pod and/or integument of the seed.

Preferably, such seeds comprise an effective amount of the arylcarboxylic acid biphenylamide I. Accordingly, the seeds are coated, impregnated or coated and impregnated in such a manner that pest damage during germination and emergence is reduced.

The seeds treated with an arylcarboxylic acid biphenylamide of formula I may also be enveloped with a film overcoating to protect the arylcarboxylic acid biphenylamide I coating. Such overcoatings are known in the art and may be applied using conventional fluidized bed and drum film coating techniques.

The seeds of the present invention can be used for the propagation of plants. The seeds can be stored, handled, planted/sowed and tilled.

Unless indicated otherwise, all amounts in % by weight refer to the weight of the total composition (or formulation).

The following examples shall further illustrate the invention without limiting it.

### EXAMPLES

### Application Example 1

### Activity Against Septoria tritici on Wheat (Seed Treatment)

9.6 mg of the active compound Ia.90 was dissolved in 1 ml of acetone to give a stock solution. The stock solution was diluted with acetone to give the test solution. Aliquots of 4.8 g of wheat seeds were placed in glass vials, where they were treated in an air stream with 0.5 ml of the test solution containing the active compound. In each case, 10 grains were sown in pots of 8 cm diameter. Untreated grains served as control. 14 days after sowing, the wheat plants were inoculated with a spore suspension of Septoria tritici. After 24 days of incubation, the extent of infection was determined visually in %. The results are compiled in table 1. The concentration is given in g of active compound (g a.i.) per 100 kg of seeds.

TABLE 1

| Compound | Concentration [g a.i./100 kg] | Infected leaf area [%] |
|---|---|---|
| control | — | 85 |
| Ia.90 | 100 | 0 |
| | 50 | 0 |
| | 25 | 1 |

### Application Example 2

### Activity Against Puccinia recondita on Wheat (Seed Treatment)

24 mg of the active compounds listed in table 2 were in each case dissolved in 1 ml of acetone to give a stock solution. The stock solution was diluted with acetone to give the test solution. Aliquots of 4.8 g of wheat seeds were placed in glass vials, where they were treated in an air stream with 1 ml of the test solution containing the active compound. In each case, 10 grains were sown in pots of 8 cm diameter. Untreated grains served as control. 14 days after sowing, the wheat plants were inoculated with a spore suspension of Septoria tritici. After 7 days of incubation, the extent of infection was determined visually in %. The results are compiled in table 2. The concentration is given in g of active compound (g a.i.) per 100 kg of seeds.

TABLE 2

| Compound | Concentration [g a.i./100 kg] | Infected leaf area [%] |
|---|---|---|
| control | — | 90 |
| Ia.90 | 250 | 0 |
| Ia.85 | 250 | 11 |
| Ia.245 | 250 | 19 |
| Ia.255 | 250 | 38 |

### Application Example 3

### Activity Against Phakopsora pachyrhizi on soybean (Seed Treatment)

16 mg of the active compounds listed in table 3 were in each case dissolved in 1 ml of acetone to give a stock solution. The stock solution was diluted with acetone to give the test solution. Aliquots of 1.5 g of soybean seeds were placed in glass vials, where they were treated in an air stream with 0.6 ml of the test solution containing the active compound. In each case, 8 grains were sown in pots of 8 cm diameter. Untreated grains served as control. 14 days after sowing, the soybean plants were inoculated with a spore suspension of Phakopsora pachyrhizi. After 10 days of incubation, the extent of infection was determined visually in %. The results are compiled in table 3. The concentration is given in g of active compound (g a.i.) per 100 kg of seeds.

TABLE 3

| Compound | Concentration [g a.i./100 kg] | Infected leaf area [%] |
|---|---|---|
| control | — | 87 |
| Ia.90 | 250 | 2 |
| | 125 | 1 |

### Application Example 4

### Activity Against Septoria tritici on Wheat

The active compound Ia.1 was formulated as a stock solution in dimethyl sulfoxide at a concentration of 10 000 ppm. The stock solution was diluted with water to the stated active compound concentration. 1 ml of the respective solution was pipetted to wheat seedlings grown in vermiculite (10 to 12 seedlings per pot). 7 days after the treatment the wheat plants were inoculated with a spore suspension of Septoria tritici. After 18 days of incubation, the extent of infection was determined visually in %. The results are compiled in table 4. The concentration is given in g of active compound (g a.i.) per 100 kg of seeds.

TABLE 4

| Compound | Concentration [g a.i./100 kg] | Infected leaf area [%] |
|---|---|---|
| control | — | 60 |
| Ia.90 | 250 | 0 |
| | 125 | 0 |

### Application Example 5

### Activity Against Septoria tritici on Wheat

The active compound Ia.1 was formulated as a stock solution in acetone at a concentration of 10 000 ppm. The stock solution was diluted with water to the stated active compound concentration. 1 ml of the respective solution was pipetted to wheat seedlings grown in vermiculite (10 to 12 seedlings per pot). 7 days after the treatment leaf portions of 5 cm length were placed in petri dishes filled with aqueous agar. The leaf portions were then inoculated with a spore suspension of Septoria tritici. The closed Petri dishes were incubated in a climatized test cabinet at 18° C. and 12 h light exposure per day. After 18 days of incubation, the extent of infection was determined visually in %. The results are compiled in table 5. The concentration is given in g of active compound (g a.i.) per 100 kg of seeds.

TABLE 5

| Compound | Concentration [g a.i./100 kg] | Infected leaf area [%] |
|---|---|---|
| control | — | 100 |
| Ia.84 | 250 | 3 |
| | 125 | 3 |
| Ia.85 | 250 | 0 |
| | 125 | 0 |
| Ia.90 | 250 | 3 |
| | 125 | 7 |
| Ia.110 | 250 | 7 |
| | 125 | 3 |
| Ia.233 | 250 | 0 |
| | 125 | 7 |
| Ia.245 | 250 | 0 |
| | 125 | 0 |
| Ia.255 | 250 | 3 |
| | 125 | 3 |
| Ia.313 | 250 | 0 |
| | 125 | 0 |

### Application Example 6

### Activity Against Puccinia recondita on Wheat

The active compounds were formulated as a stock solution in acetone at a concentration of 10 000 ppm. The stock solution was diluted with water to the stated active compound concentration. 1 ml of the respective solution was pipetted to wheat seedlings grown in vermiculite (10 to 12 seedlings per pot). 7 days after the treatment the wheat plants were inoculated with a spore suspension of Puccinia recondita. After 7 days of incubation, the extent of infection was determined visually in %. The results are compiled in table 6. The concentration is given in g of active compound (g a.i.) per 100 kg of seeds.

TABLE 6

| Compound | Concentration [g a.i./100 kg] | Infected leaf area [%] |
|---|---|---|
| control | — | 80 |
| Ia.43 | 250 | 0 |
| | 125 | 0 |
| Ia.44 | 250 | 0 |
| | 125 | 0 |
| Ia.45 | 250 | 0 |
| | 125 | 0 |
| Ia.57 | 250 | 0 |
| | 125 | 0 |
| Ia.64 | 250 | 0 |
| | 125 | 0 |
| Ia.84 | 250 | 0 |
| | 125 | 0 |
| Ia.85 | 250 | 0 |
| | 125 | 0 |
| Ia.90 | 250 | 1 |
| | 125 | 2 |
| Ia.173 | 250 | 0 |
| | 125 | 0 |
| Ia.211 | 250 | 0 |
| | 125 | 0 |
| Ia.219 | 250 | 6 |
| | 125 | 8 |
| Ia.230 | 250 | 0 |
| | 125 | 0 |
| Ia.231 | 250 | 0 |
| | 125 | 0 |
| Ia.233 | 250 | 0 |
| | 125 | 2 |
| Ia.244 | 250 | 0 |
| | 125 | 0 |
| Ia.245 | 250 | 0 |
| | 125 | 0 |
| Ia.249 | 250 | 0 |
| | 125 | 0 |
| Ia.250 | 250 | 0 |
| | 125 | 0 |
| Ia.251 | 250 | 0 |
| | 125 | 0 |
| Ia.255 | 250 | 0 |
| | 125 | 0 |
| Ia.313 | 250 | 0 |
| | 125 | 0 |
| Id.55 | 250 | 0 |
| | 125 | 0 |
| Id.56 | 250 | 0 |
| | 125 | 0 |
| Id.58 | 250 | 13 |
| | 125 | 13 |

### Application Example 7

### Activity Against Erysiphe graminis on Wheat

The active compounds were formulated as a stock solution in acetone at a concentration of 10 000 ppm. The stock solution was diluted with water to the stated active compound concentration. 1 ml of the respective solution was pipetted to wheat seedlings grown in vermiculite (10 to 12 seedlings per pot). 7 days after the treatment the wheat plants were inoculated with a spore suspension of Erysiphe graminis. After 7 days of incubation, the extent of infection was determined visually in %. The results are compiled in table 7. The concentration is given in g of active compound (g a.i.) per 100 kg of seeds.

TABLE 7

| Compound | Concentration [g a.i./100 kg] | Infected leaf area [%] |
|---|---|---|
| control | — | 80 |
| Ia.43 | 250 | 0 |
| | 125 | 2 |
| Ia.84 | 250 | 0 |
| | 125 | 0 |
| Ia.85 | 250 | 0 |
| | 125 | 0 |
| Ia.90 | 250 | 0 |
| | 125 | 0 |
| Ia.110 | 250 | 0 |
| | 125 | 0 |
| Ia.173 | 250 | 0 |
| | 125 | 0 |
| Ia.211 | 250 | 0 |
| | 125 | 0 |
| Ia.245 | 250 | 0 |
| | 125 | 0 |
| Ia.255 | 250 | 0 |
| | 125 | 0 |
| Ia.313 | 250 | 0 |
| | 125 | 0 |

### Application Example 8

### Activity Against Phakopsora pachyrhizi on Soybean

The active compounds were formulated as a stock solution in dimethylsulfoxide at a concentration of 10 000 ppm. The stock solution was diluted with water to the stated active compound concentration. 1 ml of the respective solution was pipetted to soybean seedlings grown in vermiculite (1 seedling per pot). 7 days after the treatment the soybean plants were inoculated with a spore suspension of Phakopsora pachyrhizi. After 14 days of incubation, the extent of infection was determined visually in %. The results are compiled in table 8. The concentration is given in g of active compound (g a.i.) per 100 kg of seeds.

TABLE 8

| Compound | Concentration [g a.i./100 kg] | Infected leaf area [%] |
|---|---|---|
| control | — | 88 |
| Id.1 | 250 | 40 |
| Ia.90 | 250 | 0 |
| Ia.110 | 250 | 17 |
| Ia.211 | 250 | 3 |
| Ia.245 | 250 | 0 |

1-37. (canceled)

38. A method for protecting plants after germination from the attack of foliar phytopathogenic fungi comprising,
treating the seed from which the plants are to grow with an effective amount of at least one arylcarboxylic acid biphenylamide of the formula I 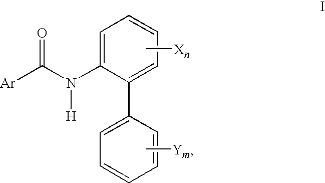
wherein
X is halogen or methyl;
n is zero, 1 or 2, wherein when n is 2, the radicals X may have the same or different meanings;
Y is cyano, nitro, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkoxy-iminomethyl or allyloxyiminomethyl;
m is zero to 5, wherein when m is 2, 3, 4 or 5, the radicals Y may have the same or different meanings;
Ar is an aryl radical of the formula IIa, IIb or IIc 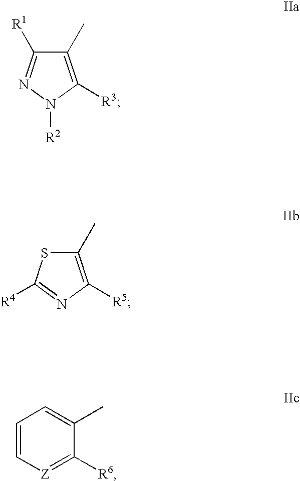
wherein
R¹ is hydrogen, halogen, C₁-C₄-alkyl or C₁-C₄-haloalkyl,
R¹ is C₁-C₄-alkyl,
R² is hydrogen, halogen or methyl,
R³ is hydrogen, halogen or C₁-C₄-alkyl,
R⁴ is C₁-C₄-alkyl or C₁-C₄-haloalkyl,
Z is CH or N and
is halogen, C₁-C₄-alkyl or C₁-C₄-haloalkyl
or an agriculturally acceptable salt thereof.

39. The method of claim 38, wherein Ar is an aryl radical of the formula IIa.

40. The method of claim 39, wherein R¹ is C₁-C₂-haloalkyl.

41. The method of claim 39, wherein R³ is hydrogen.

42. The method of claim 39, wherein Y is selected from halogen, C₁-C₄-alkyl, C₁-C₄-haloalkyl and C₁-C₄-haloalkylthio, and m is 1, 2 or 3.

43. The method of claim 39, wherein X is halogen and n is 0 or 1.

44. The method of claim 38, wherein Ar is an aryl radical of the formula IIb.

45. The method of claim 38, wherein Ar is an aryl radical of the formula IIc with X being N.

46. The method of claim 45, wherein R⁶ is halogen.

47. The method of claim 45, wherein n is 0, Y is halogen and m is 1.

48. The method according to claim 38, wherein Ar is an aryl radical of the formula IIc with X being CH.

49. The method of claim 38, wherein said treating the seed from which the plants are to grow with an effective amount of at least one arylcarboxylic acid biphenylamide of the formula I, further comprises treating together with at least one fungicidal active ingredient, selected from the group consisting of
azoles selected from the group consisting of bromoconazole, cyproconazole, difenoconazole, epoxyconazole, fluquinconazole, flusilazole, flutriafole, hexaconazole, imazalil, metconazole, myclobutanil, penconazole, propiconazole, prochloraz, prothioconazole, tebuconazole, tetraconazole, triadimefon, triadimenol and triticonazole;
acylalanine selected from the group consisting of benalaxyl, metalaxyl, mefenoxam, ofurace and oxadixyl;
guazatine;
anilinopyrimidines selected from the group consisting of pyrimethanil, mepanipyrim and cyprodinil;
dicarboximides selected from the group consisting of iprodione, procymidone and vinclozolin;
dithiocarbamates selected from the group consisting of mancozeb, metiram and thiram;
heterocyclic compounds selected from the group consisting of benomyl, carbendazim, carboxin, oxycarboxin, fuberidazole, picobenzamide, penthiopyrad, proquinazide, thiabendazole and thiophanate-methyl;
phenylpyrroles selected from the group consisting of fenpiclonil and fludioxonil;
other fungicides selected from the group consisting of benthiavalicarb, cyflufenamide, fosetyl, fosetyl-aluminium, phosphoric acid and its salts, iprovalicarb, metrafenone and 5-chloro-7-(4-methyl-piperidin-1-yl)-6-(2,4,6-trifluorophenyl)-[1,2,4]triazolo-[1,5-a]pyrimidine;
strobilurines selected from the group consisting of azoxystrobin, dimoxystrobin, enestrobin, enestroburin, fluoxastrobin, kresoxim-methyl, metominostrobin, orysa-strobin, picoxystrobin, pyraclostrobin, trifloxystrobin, methyl (2-chloro-5-[1-(3-methyl-benzyloxy-imino)-ethyl]-benzyl)-carbamate, methyl (2-chloro-5-[1-(6-methyl-pyridin-2-ylmethoxyimino)-ethyl]-benzyl)-carbamate and methyl 2-ortho-[(2,5-dimethyl-phenyl-oxymethylen)phenyl]-3-methoxy-acrylate; and
zinnamic acid amides and analogous selected from the group consisting of dimethomorph, flumetover and flumorph.

50. The method of claim 38 wherein said treating the seed from which the plants are to grow with an effective amount of at least one arylcarboxylic acid biphenylamide of the formula I, further comprises treating together with at least one insecticidal active ingredient selected from the group consisting of acetamiprid, alpha-cypermethrin, beta-cypermethrin, bifenthrin, carbofuran, carbosulfan, clothianidin, cycloprothrin, cyfluthrin, cypermethrin, deltamethrin, diflubenzuron, dinotefuran, etofenprox, fenbutatin-oxide, fenpropathrin, fipronil, flucythrinate, imidacloprid, lambda-cyhalothrin, nitenpyram, pheromones, spinosad, teflubenzuron, tefluthrin, terbufos, thiacloprid, thiamethoxam, thiodicarb, tralomethrin, triazamate, zeta-cypermethrin, spirotetramat, flupyrazofos, tolfenpyrad, flubendiamide, bistrifluoron, benclothiaz, pyrafluprole, pyriprole, amidoflumet, flufenerim, cyflumetofen, cyenopyrafen, the anthranilamide compound of formula Γ² 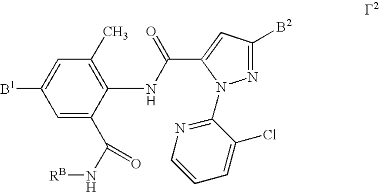
wherein B¹ is Cl, B² is Br and R^{B} is CH₃, and the anthranilamide compound of formula γ² wherein B¹ is CN, B² is Br and R^{B} is CH₃.

51. The method of claim 50, where the insecticidal active ingredient is selected from fipronil, imidacloprid, acetamipird, nitenpyram, carbofuran, carbosulfan, benfuracarb, thiacloprid, clothianidin, dinotefuran and thiamethoxam.

52. The method of claim 38, wherein the seed is of a tuberous or corn vegetable, a leafy vegetable, a leafy brassica green, or a fruiting vegetable.

53. The method of claim 38, wherein the seed is of a leguminous plant.

54. The method of claim 53, wherein the seed is soybean seed.

55. The method of claim 38, wherein the seed is of a cereal.

56. The method of claim 38, wherein said plants are in the growth stage 09 (extended BBCH scale) or higher.

57. The method of claim 38, wherein said effective amount is from 1 to 500 g per 100 kilograms of seed.

58. The method of claim 38, wherein said treatment is seed dressing.

59. A seed treatment formulation comprising at least one arylcarboxylic acid biphenylamide of the formula I 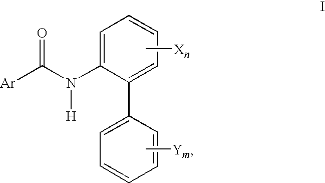
wherein
X is halogen or methyl;
n is zero, 1 or 2, wherein when n is 2, the radicals X may have the same or different meanings;
Y is cyano, nitro, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkoxy-iminomethyl or allyloxyiminomethyl;
m is zero to 5, wherein when m is 2, 3, 4 or 5, the radicals Y may have the same or different meanings;
Ar is an aryl radical of the formula IIa, IIb or IIc 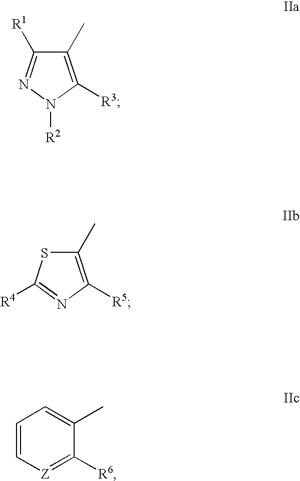
wherein
R¹ is hydrogen, halogen, C₁-C₄-alkyl or C₁-C₄-haloalkyl,
R² is C₁-C₄-alkyl,
R³ is hydrogen, halogen or methyl,
R⁴ is hydrogen, halogen or C₁-C₄-alkyl,
R⁵ is C₁-C₄-alkyl or C₁-C₄-haloalkyl,
Z is CH or N and
R⁶ is halogen, C₁-C₄-alkyl or C₁-C₄-haloalkyl
or an agriculturally acceptable salt thereof, and
at least one seed treatment auxiliary agent.

60. The formulation of claim 59, comprising between 0.005% by weight and 95% by weight of said at least one arylcarboxylic acid biphenylamide I.

61. The formulation of claim 59, further comprising at least one fungicidal active ingredient, selected from the group consisting of
azoles selected from the group consisting of bromoconazole, cyproconazole, difenoconazole, epoxyconazole, fluquinconazole, flusilazole, flutriafole, hexaconazole, imazalil, metconazole, myclobutanil, penconazole, propiconazole, prochloraz, prothioconazole, tebuconazole, tetraconazole, triadimefon, triadimenol and triticonazole;
acylalanines selected from the group consisting of benalaxyl, metalaxyl, mefenoxam, ofurace and oxadixyl;
guazatine;
anilinopyrimidines selected from the group consisting of pyrimethanil, mepanipyrim and cyprodinil;
dicarboximides selected from the group consisting of iprodione, procymidon and vinclozolin;
dithiocarbamates selected from the group consisting of mancozeb, metiram and thiram;
heterocyclic compounds selected from the group consisting of benomyl, carbendazim, carboxin, oxycarboxin, fuberidazol, picobenzamid, penthiopyrad, proquinazid, thiabend-azole and thiophanate-methyl;
phenylpyrroles selected from the group consisting of fenpiclonil and fludioxonil;
other fungicides, for example benthiavalicarb, cyflufenamide, fosetyl, fosetyl-aluminium, phosphoric acid and its salts, iprovalicarb, metrafenone and 5-chloro-7-(4-methyl-piperidin-1-yl)-6-(2,4,6-trifluorophenyl)-[1,2,4]triazolo[1,5-a]pyrimidine;
strobilurines selected from the group consisting of azoxystrobin, dimoxystrobin, enestrobin, enestroburin, fluoxastrobin, kresoxim-methyl, metominostrobin, orysa-strobin, picoxystrobin, pyraclostrobin, trifloxystrobin, methyl (2-chloro-5-[1-(3-methyl-benzyloxy-imino)-ethyl]-benzyl)-carbamate, methyl (2-chloro-5-[1-(6-methyl-pyridin-2-ylmethoxyimino)-ethyl]-benzyl)-carbamate and methyl 2-ortho-[(2,5-dimethyl-phenyl-oxymethylen)phenyl]-3-methoxy-acrylate; and
cinnamic acid amides and analogous selected from the group consisting of dimethomorph, flumetover and flumorph.

62. The formulation of claim 59, further comprising at least one insecticidal active ingredient, selected from the group consisting of acetamiprid, alpha-cypermethrin, beta-cypermethrin, bifenthrin, carbofuran, carbosulfan, clothianidin, cycloprothrin, cyfluthrin, cypermethrin, deltamethrin, diflubenzuron, dinotefuran, etofenprox, fenbutatin-oxide, fenpropathrin, fipronil, flucythrinate, imidacloprid, lambda-cyhalothrin, nitenpyram, pheromones, spinosad, teflubenzuron, tefluthrin, terbufos, thiacloprid, thiamethoxam, thiodicarb, tralomethrin, triazamate, zeta-cypermethrin, spirotetramat, flupyrazofos, tolfenpyrad, flubendiamide, bistrifluoron, benclothiaz, pyrafluprole, pyriprole, amidoflumet, flufenerim, cyflumetofen, cyenopyrafen, the anthranilamide compound of formula γ² 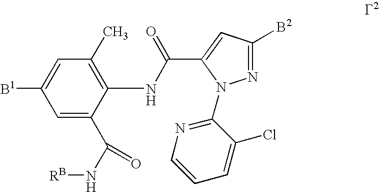
wherein B¹ is Cl, B² is Br and R^{B} is CH₃,
and the anthranilamide compound of formula γ² wherein B¹ is CN, B² is Br and R^{B} is CH₃.

63. The formulation of claim 62, wherein said insecticidal active ingredient is selected from fipronil, imidacloprid, acetamipird, nitenpyram, carbofuran, carbosulfan, benfuracarb, thiacloprid, clothianidin, dinotefuran and thiamethoxam.

64. The formulation of claim 59, wherein said formulation comprises a mammal/bird repellent.

65. The formulation of claim 59, wherein said seed treatment auxiliary agent is a seed coating auxiliary agent, a solid matrix material, a penetration enhancer, a colorant, an antifreeze, and/or a gelling agent.

66. The formulation of claim 59, wherein said seed coating auxiliary agent is a binder.

67. A seed treated with the method of claim 38.

68. A seed comprising at least one arylcarboxylic acid biphenylamide of the formula I 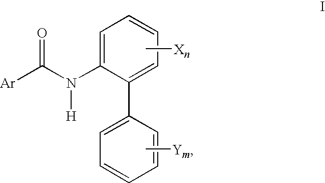
wherein
X is halogen or methyl;
n is zero, 1 or 2, wherein when n is 2, the radicals X may have the same or different meanings;
Y is cyano, nitro, halogen, C₁-C₄-alkyl, C₁-C₄-haloalkyl, C₁-C₄-alkoxy, C₁-C₄-haloalkoxy, C₁-C₄-alkylthio, C₁-C₄-haloalkylthio, C₁-C₄-alkoxy-iminomethyl or allyloxyiminomethyl;
m is zero to 5, wherein when m is 2, 3, 4 or 5, the radicals Y may have the same or different meanings;
Ar is an aryl radical of the formula IIa, IIb or IIc 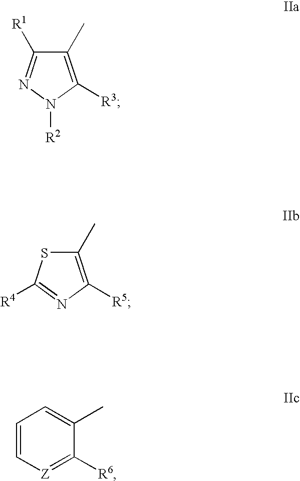
wherein
R¹ is hydrogen, halogen, C₁-C₄-alkyl or C₁-C₄-haloalkyl,
R² is C₁-C₄-alkyl,
R³ is hydrogen, halogen or methyl,
R⁴ is hydrogen, halogen or C₁-C₄-alkyl,
R⁵ is C₁-C₄-alkyl or C₁-C₄-haloalkyl,
Z is CH or N and
R⁶ is halogen, C₁-C₄-alkyl or C₁-C₄-haloalkyl
or with an agriculturally acceptable salt thereof,
and optionally at least one fungicidal active ingredient, selected from the group consisting of
azoles selected from the group consisting of bromoconazole, cyproconazole, difenoconazole, epoxyconazole, fluquinconazole, flusilazole, flutriafol, hexaconazole, imazalil, metconazole, myclobutanil, penconazole, propiconazole, prochloraz, prothioconazole, tebuconazole, tetraconazole, triadimefon, triadimenol and triticonazole;
acylalanines selected from the group consisting of benalaxyl, metalaxyl, mefenoxam, ofurace and oxadixyl;
guazatine;
anilinopyrimidines selected from the group consisting of pyrimethanil, mepanipyrim or cyprodinil;
dicarboximides selected from the group consisting of iprodione, procymidon and vinclozolin;
dithiocarbamates selected from the group consisting of mancozeb, metiram and thiram;
heterocyclic compounds selected from the group consisting of benomyl, carbendazim, carboxin, oxycarboxin, fuberidazole, picobenzamide, penthiopyrad, proquinazid, thiabendazol and thiophanate-methyl;
phenylpyrroles selected from the group consisting of fenpiclonil and fludioxonil;
other fungicides, for example benthiavalicarb, cyflufenamide, fosetyl, fosetyl-aluminium, phosphoric acid and its salts, iprovalicarb, metrafenone and 5-chloro-7-(4-methyl-piperidin-1-yl)-6-(2,4,6-trifluorophenyl)-[1,2,4]triazolo[1,5-a]pyrimidine;
strobilurines such as azoxystrobin, dimoxystrobin, enestrobin, enestroburin, fluoxa-strobin, kresoxim-methyl, metominostrobin, orysastrobin, picoxystrobin, pyraclo-strobin, trifloxystrobin, methyl (2-chloro-5-[1-(3-methyl-benzyloxyimino)-ethyl]-benzyl)-carbamate, methyl (2-chloro-5-[1-(6-methyl-pyridin-2-ylmethoxyimino)-ethyl]-benzyl)-carbamate and 2-ortho-[(2,5-dimethylphenyl-oxymethylen)phenyl]-3-methoxy-acrylate; and
cinnamic acid amides and analogous selected from the group consisting of dimethomorph, flumetover and flumorph,
and/or at least one insecticidal active ingredient, selected from the group consisting of acetamiprid, alpha-cypermethrin, beta-cypermethrin, bifenthrin, carbofuran, carbosulfan, clothianidin, cycloprothrin, cyfluthrin, cypermethrin, deltamethrin, diflubenzuron, dinotefuran, etofenprox, fenbutatin-oxide, fenpropathrin, fipronil, flucythrinate, imidacloprid, lambda-cyhalothrin, nitenpyram, pheromones, spinosad, teflubenzuron, tefluthrin, terbufos, thiacloprid, thiamethoxam, thiodicarb, tralomethrin, triazamate, zeta-cypermethrin, spirotetramat, flupyrazofos, tolfenpyrad, flubendiamide, bistrifluoron, benclothiaz, pyrafluprole, pyriprole, amidoflumet, flufenerim, cyflumetofen, cyenopyrafen, the anthranilamide compound of formula Γ² 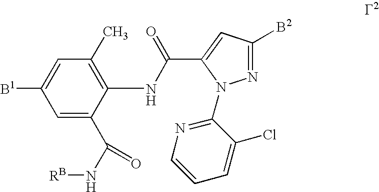
where B¹ is Cl, B² is Br and R^{B} is CH₃,
and the anthranilamide compound of formula Γ² where B is CN, B² is Br and R^{B} is CH₃.

69. The seed of claim 68, wherein said seed has a coating, said coating comprising said at least one arylcarboxylic acid biphenylamide of the formula I, and optionally at least one said fungicidal active ingredient, and/or at least one said insecticidal active ingredient.

70. The seed of claim 69, wherein said at least one insecticidal active ingredient is selected from the group consisting of fipronil, imidacloprid, acetamipird, nitenpyram, carbofuran, carbosulfan, benfuracarb, thiacloprid, clothianidin, dinotefuran and thiamethoxam.
